(19) United States
(12) Patent Application Publication
(10) Pub. No.: US 2025/0390733 A1
(43) Pub. Date: Dec. 25, 2025

(54) ARTIFICIAL INTELLIGENCE TRAINING SYSTEM

(71) Applicant: SanDisk Technologies LLC, Austin, TX (US)

(72) Inventors: Cyril Guyot, San Jose, CA (US); Robert Eugeniu Mateescu, San Jose, CA (US); Minghai Qin, Fremont, CA (US)

(21) Appl. No.: 18/748,826

(22) Filed: Jun. 20, 2024

(51) Int. Cl. G06N 3/08; G06N 3/045

(52) U.S. Cl. CPC G06N 3/08; G06N 3/045

(57) ABSTRACT

A computing system is provided that includes at least one processing unit, at least one high bandwidth memory (HBM) unit, and at least one high bandwidth flash (HBF) unit. The HBM and HBF units are all in electrical communication with the at least one processing unit. The computing system also includes control circuitry that is configured to train a large language model according to a low-rank adaptation (LoRA) technique. The control circuitry is configured to store a full-weight matrix in the at least one HBF unit and to store at least one low-rank matrix in the at least one HBM unit.

### BACKGROUND

Semiconductor memory is widely used in various electronic devices such as cellular telephones, digital cameras, personal digital assistants, medical electronics, mobile computing devices, servers, solid state drives, non-mobile computing devices and other devices. Semiconductor memory may be non-volatile memory or volatile memory. A non-volatile memory allows information to be stored and retained even when the non-volatile memory is not connected to a source of power (e.g., a battery).

Non-volatile memory devices include one or more memory chips having multiple arrays of memory cells. The memory arrays may have associated decoders and circuits for performing read, write, and erase operations. Memory cells within the arrays may be arranged in horizontal rows and vertical columns. Each row may be addressed by a word line, and each column may be addressed by a bit line. Data may be loaded into columns of the array using a series of data busses. Each column may hold a predefined unit of data, for instance, a word encompassing two bytes of information.

In some applications, semiconductor memory is used to store very large amounts of data that are repeatedly accessed (e.g., read) very rapidly. For example, in some machine learning applications, training large language models (LLMs) requires both a very high amount of storage capacity and also a very high bandwidth. At the core of such LLMs are neural networks, which are composed of layers of interconnected nodes, or neurons, that process input data. The connections between these neurons are defined by weight matrices, which are essentially tables of numerical values that determine how much influence one neuron has on another. During training, the model is fed vast amounts of text data, and it learns by adjusting the values in these weight matrices through a method called backpropagation. This method calculates the error in the output of the model and propagates it back through the network, updating the weights to minimize this error. Over time, the adjustments to the weight matrices enable the model to make more accurate predictions about language patterns, such as the likelihood of a word following a given sequence of words. The training process is computationally intensive and requires a large dataset and significant processing power to iteratively improve the model's performance.

Currently, high bandwidth volatile memory devices (e.g., DRAM memory devices called “high bandwidth memory” or “HBM”) are used for such LLM training applications. Non-volatile memory (e.g., NAND) is significantly less expensive than DRAM and generally offers much higher storage capacity, but the bandwidth of conventional NAND memory devices is often too low to be effective in these applications.

### SUMMARY

One aspect of the present disclosure is related to a method of training a large language model using a low rank adaptation (LoRA) technique. The method includes the step of preparing a computing system that includes at least one processing unit and at least one high bandwidth memory (HBM) unit in electrical communication with the at least one processing unit and at least one high bandwidth flash (HBF) unit in electrical communication with the at least one processing unit. The method continues with the steps of storing a full-weight matrix in the at least one HBF unit and storing at least one low-rank matrix in the at least one HBM unit.

According to another aspect of the present disclosure, the method further includes the step of generating the at least one low-rank matrix from the full-weight matrix.

According to yet another aspect of the present disclosure, the step of generating the at least one low rank matrix from the full-weight matrix includes the step of generating a pair of low-rank matrices from the full-weight matrix.

According to still another aspect of the present disclosure, the method further includes the step of adjusting the low-rank matrices based on an input.

According to a further aspect of the present disclosure, after the step of adjusting the low-rank matrices based on the input, the method further includes the step of adjusting the full-weight matrix based on the adjusted low-rank matrices.

According to yet a further aspect of the present disclosure, the at least one HBF unit includes a plurality of HBF units that do not allow random access. The plurality of HBF units have arrays of memory cells that are arranged in a plurality of word lines and memory holes.

According to still a further aspect of the present disclosure, the at least one HBM unit includes a plurality of HBM units that allow random access.

According to another aspect of the present disclosure, the plurality of HBM units are dynamic random access memory (DRAM).

According to yet another aspect of the present disclosure, the at least one HBF unit has a bandwidth of at least 3 TB/s.

Another aspect of the present disclosure is related to a computing system that includes at least one processing unit, at least one high bandwidth memory (HBM) unit in electrical communication with the at least one processing unit, and at least one high bandwidth flash (HBF) unit in electrical communication with the at least one processing unit. The computing system also includes control circuitry that is configured to train a large language model according to a low-rank adaptation (LoRA) technique. The control circuitry is configured to store a full-weight matrix in the at least one HBF unit and to store at least one low-rank matrix in the at least one HBM unit.

According to another aspect of the present disclosure, the control circuitry is configured to generate the at least one low-rank matrix from the full-weight matrix.

According to yet another aspect of the present disclosure, the at least one low-rank matrix includes a pair of low-rank matrices.

According to still another aspect of the present disclosure, the control circuitry is configured to adjust the low-rank matrices based on an input.

According to a further aspect of the present disclosure, after adjusting the low-rank matrices based on the input, the control circuitry is configured to adjust the full-weight matrix based on the adjusted low-rank matrices.

According to still a further aspect of the present disclosure, the at least one HBF unit includes a plurality of HBF units that do not allow random access, and the plurality of HBF units have arrays of memory cells that are arranged in a plurality of word lines and memory holes.

According to another aspect of the present disclosure, the at least one HBM unit includes a plurality of HBM units that allow random access.

According to yet another aspect of the present disclosure, the plurality of HBM units are dynamic random access memory (DRAM).

According to still another aspect of the present disclosure, the at least one HBF unit has a bandwidth of at least 3 TB/s.

Yet another aspect of the present disclosure is related to an apparatus that includes at least one processing unit, at least one high bandwidth memory (HBM) unit that is volatile and is in electrical communication with the at least one processing unit, and at least one high bandwidth flash (HBF) unit that is non-volatile and is in electrical communication with the at least one processing unit. The apparatus also includes an artificial intelligence training means for training a large language model according to a low-rank adaptation (LoRA) technique. The artificial intelligence training means is configured to store a full-weight matrix in the at least one HBF unit and to store at least one low-rank matrix in the at least one HBM unit.

According to another aspect of the present disclosure, the artificial intelligence training means is configured to adjust the at least one low-rank matrix based on an input and then adjust the full-weight matrix based on the adjusted at least one low-rank matrix.

### BRIEF DESCRIPTION OF THE DRAWINGS

A more detailed description is set forth below with reference to example embodiments depicted in the appended figures. Understanding that these figures depict only example embodiments of the disclosure and are, therefore, not to be considered limiting of its scope. The disclosure is described and explained with added specificity and detail through the use of the accompanying drawings in which:

FIG. 1 is a perspective view of an exemplary embodiment of a computing system that is particularly adapted for LLM training;

FIG. 2 is a schematic view of the computing system of FIG. 1 in use during an LLM training operation;

FIG. 3 is a block diagram depicting one embodiment of a storage system;

FIG. 4A is a block diagram of one embodiment of a memory die;

FIG. 4B is a block diagram of one embodiment of an integrated memory assembly;

FIGS. 5A and 5B depict different embodiments of integrated memory assemblies;

FIG. 6A is a perspective view of a portion of one embodiment of a monolithic three dimensional memory structure;

FIG. 6B is a block diagram of one embodiment of a memory structure having four planes;

FIG. 6C depicts a top view of a portion of one embodiment of a block of memory cells;

FIG. 6D depicts a cross sectional view of a portion of one embodiment of a block of memory cells;

FIG. 6E depicts a cross sectional view of a portion of one embodiment of a block of memory cells;

FIG. 6F is a cross sectional view of one embodiment of a vertical column of memory cells;

FIG. 6G is a schematic of a plurality of NAND strings in multiple regions of a same block;

FIG. 7A is a block diagram of one embodiment of a memory structure having four planes;

FIG. 7B is a block diagram of one embodiment of a memory structure having thirty-two planes;

FIG. 7C is a block diagram of another embodiment of a memory structure having thirty-two planes;

FIG. 7D is a block diagram of still another embodiment of a memory structure having thirty-two planes;

FIGS. 8A-8C depict an example NAND string during inhibit, program and sensing, respectively;

FIG. 9A depicts an example threshold voltage distribution of a NAND memory cell;

FIG. 9B depicts another example threshold voltage distribution of a NAND memory cell;

FIG. 10A depicts example threshold voltage distributions of two blocks of NAND memory cells;

FIG. 10B depicts example threshold voltage distributions of a single block of NAND memory cells; and

FIG. 11 is a flow chart depicting the steps of performing a LLM training operation according to an exemplary embodiment of the present disclosure.

### DETAILED DESCRIPTION OF THE ENABLING EMBODIMENT

Technology is herein described to provide a more efficient large language model (LLM) training computing system 20 that is both cost-effective and also requires reduced computational resources. The computing system 20 includes a processing unit 22 (such as a graphics processing unit) that is in electrical communication with both at least one high bandwidth memory (HBM) unit 24 and at least one high bandwidth flash (HBF) unit 26. In the exemplary embodiment, the computing system 20 includes four HBM units 24 and four HBF units 26. However, in some other embodiments, the computing system 20 may include more or fewer of than four HBM units 24 and may include more or fewer than four HBF units 26.

The HBM units 24 (for example, dynamic random access memory—DRAM) and HBF units 26 (discussed in further detail below) offer very different advantages and disadvantages when in use. For example, the HBM units 24 have random access capabilities and generally offer much higher write performance than the HBF units 26. In contrast, HBF units 26 do not have random access capabilities but offer higher data capacity and can be manufactured more cost effectively than the HBM units 24. Also, in addition to the HBF units 26 having reduced write performance as compared to the HBM units 24, the HBF units 26 may suffer increased degradation when exposed to many program/erase cycles. As discussed in further detail below, the computing system 20 is particularly adapted for use with artificial intelligence LLM training applications where both the HBM units 24 and the HBF units 26 operate in parallel during training to enhance the advantages of and minimize the weaknesses of each. The result is a more cost effective computing system 20 that uses less computational resources during LLM processing and training as compared to other known computing systems.

Conventional LLM training techniques often involve updating weight matrices that can include billions or trillions of parameters. Each training iteration can involve updating an entire one of those weight matrices. Consequently, these approaches require both extensive bandwidth between a processing unit and a memory containing the weight matrix being trained and also substantial data capacity at the memory to even store the very large weight matrices. The memory also may be subjected to a very high number of program and erase cycles.

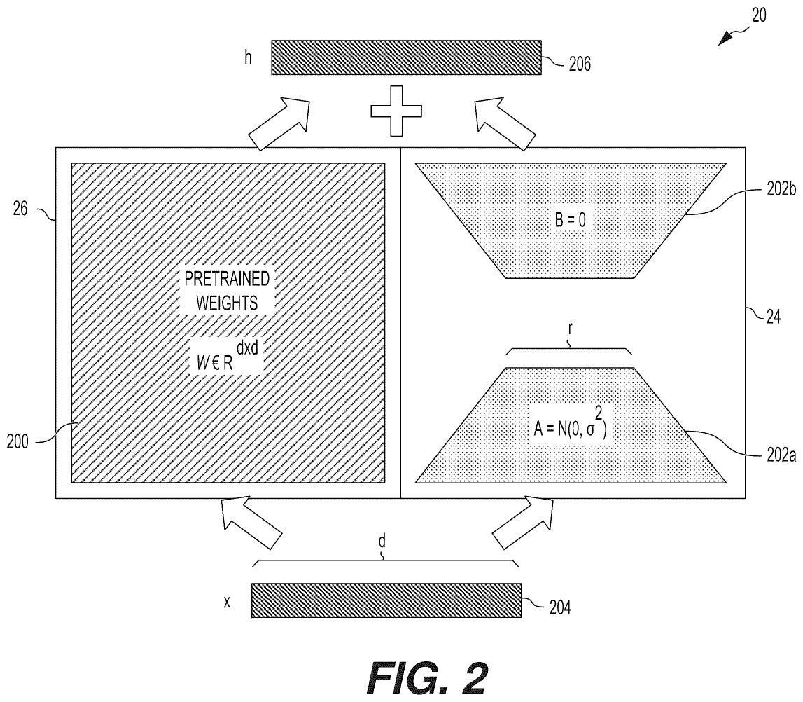

With reference now to FIG. 2, to reduce the computational resource requirement for LLM training, one technique, known as low-rank adaptation (LoRA), aims to adapt large pre-trained models with minimal computational overhead. More specifically, LLM training according to a LoRA technique involves the use of a pre-trained, full-weight matrix 200 in along with a pair of low-rank matrices 202a, 202b. The low-rank matrices 202a, 202b are derived from the full-weight matrix 200 and are optimized to capture task-specific information and contain trainable parameters which are intended to approximate the changes that would otherwise be applied to the full-weight matrix 200. In use, instead of training the entire set of weight parameters contained in the full-weight matrix 200, only the low rank matrices 202a, 202b are trained based on an input, thereby reducing the number of parameters that need to be adjusted during the training.

The full-weight matrix 200 includes “d×d” weight parameters and each of the low-rank matrices 202a, 202b has “r×d” weight parameters where “r” is the rank and is significantly less than “d”. Thus, so long as “r” is set at an appropriately low level, the low-rank matrices 202a, 202b are significantly less memory-intensive than the full-weight matrix 200.

In operation, when an input vector “x” 204 with a dimension “d” (i.e., d elements) is received at the computing system 20 the full-weight matrix 200 is translated to produce the low rank matrices 202a, 202b. In other words, the low rank matrices 202a, 202b are generated from the full-weight matrix 200.

The input vector 204 is then supplied to both the full-weight matrix 200 and to the much smaller low rank matrices 202a, 202b. The computing unit 22 (FIG. 2) then multiples the input vector 204 by the full-weight matrix 200 to produce a first intermediate vector W*x. The computing unit 22 also then multiplies the input vector 204 by both of the low-rank matrices 202a, 202b to produce a second intermediate vector B*A*x. At this time, the weight parameters of the low-rank matrices 202a, 202b may be adjusted or trained to produce enhance predictive outputs. The first and second intermediate vectors are added together to produce the output vector “h” 206, which is equal to W*x+B*A*x.

When training is considered to have converged sufficiently, then the full-weight matrix 200 is updated from the output vector h and a new cycle of LoRA can be started with a next input vector. After a certain number of LoRA cycles, the overall model may be considered to have reached an acceptable training state.

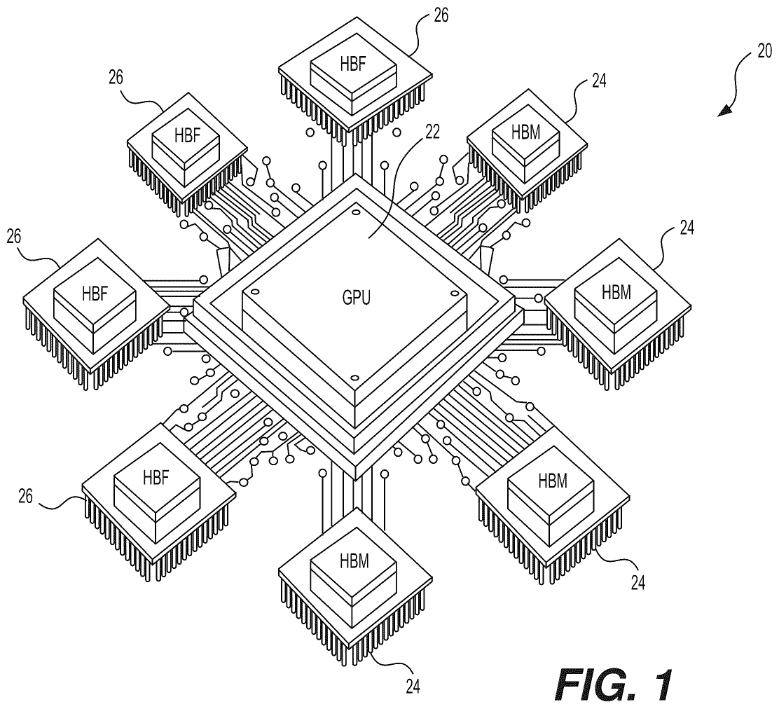

As illustrated in FIG. 2, in the exemplary embodiment of the present disclosure, the full-weight matrix 200 is stored and retained in one or more of the HBF units 26 and the low-rank matrices 202a, 202b are stored in one or more of the HBM units 24. Because the full-weight matrix 200 is infrequently updated, the reduced write performance of the HBF units 26 as compared to the HBM units 24, has little impact on the processing of the full-weight matrix 200. Further, because the full-weight matrix 200 is updated less frequently than the low-rank matrices 202a, 202b, the relatively lower write endurance of the HBF units 26 has minimal impact on the operating life of the computing system (shown in FIG. 1). On the other hand, the very high data capacity of the HBF units 26 allows for the full-weight matrix 200 to more easily be stored in the HBF units 26. The relatively higher write performance and endurance of the HBM units 24 offers improved performance during training of the low-rank matrices 202a, 202b.

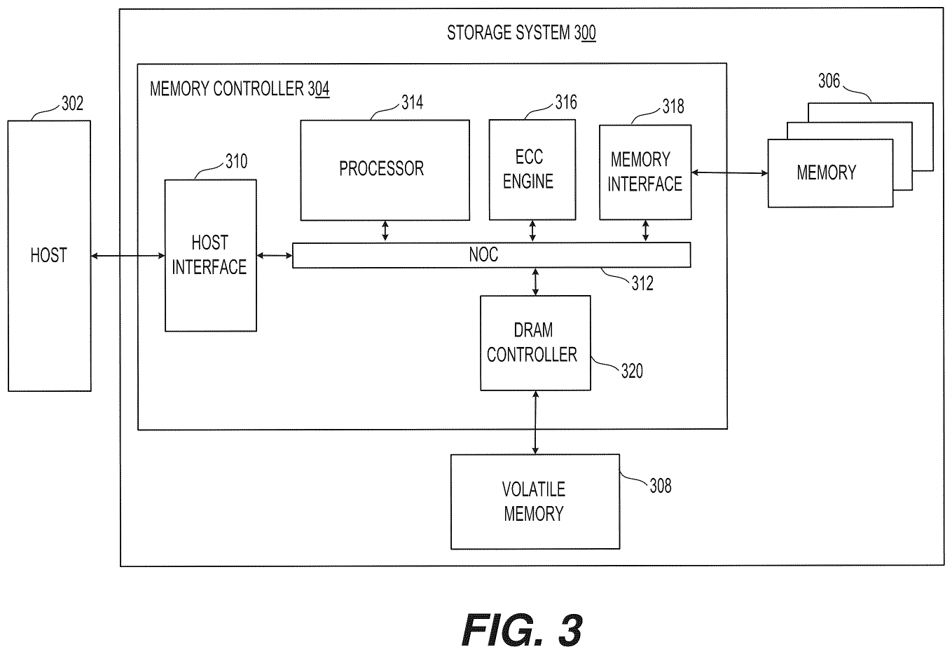

FIG. 3 is a block diagram of one embodiment of an HBF unit or storage system 300 that implements the proposed technology described herein. As discussed below, the HBF unit 300 is optimized to offer very high read performance with very low power consumption in comparison to many other known NAND memory devices. In one embodiment, the storage system 300 is a solid-state drive (“SSD”).

The storage system 300 is connected to a host 302, which can be a computer; server; electronic device (e.g., smart phone, tablet or other mobile device); appliance; or another apparatus that uses memory and has data processing capabilities. In some embodiments, the host 302 is separate from, but connected to, the storage system 300. In other embodiments, the storage system 300 is embedded within the host 302.

The components of the storage system 300 depicted in FIG. 3 are electrical circuits. The storage system 300 includes a memory controller 304 connected to non-volatile memory 306 and local high speed volatile memory 308 (e.g., DRAM). A local high speed volatile memory 308 is used by memory controller 304 to perform certain functions. For example, the local high speed volatile memory 308 stores logical to physical address translation tables (“L2P tables”).

The memory controller 304 includes a host interface 310 that is connected to and in communication with the host 302. In one embodiment, a host interface 310 implements an NVM Express (NVMe) over PCI Express (PCIe). Other interfaces can also be used, such as SCSI, SATA, etc. The host interface 310 also is connected to a network-on-chip (NOC) 312.

An NOC is a communication subsystem on an integrated circuit. The NOC's can span synchronous and asynchronous clock domains or use un-clocked asynchronous logic. NOC technology applies networking theory and methods to on-chip communications and brings notable improvements over conventional bus and crossbar interconnections. The NOC improves the scalability of systems on a chip (SoC) and the power efficiency of complex SoCs compared to other designs.

The wires and the links of the NOC are shared by many signals. A high level of parallelism is achieved because all links in the NOC can operate simultaneously on different data packets. Therefore, as the complexity of integrated subsystems keep growing, a NOC provides enhanced performance (such as throughput) and scalability in comparison with previous communication architectures (e.g., dedicated point-to-point signal wires, shared buses, or segmented buses with bridges). In other embodiments, the NOC 312 can be replaced by a bus.

Connected to and in communication with NOC 312 is a processor 314, an ECC engine 316, a memory interface 318, and a DRAM controller 320. The DRAM controller 320 is used to operate and communicate with local high speed volatile memory 308 (e.g., DRAM). In other embodiments, the local high speed volatile memory 308 can be SRAM or another type of volatile memory.

In operation, the processor 314 performs the various controller memory operations, such as programming, erasing, reading, and memory management processes. In one embodiment, the processor 314 is programmed by firmware. In other embodiments, the processor 314 is a custom and dedicated hardware circuit without any software. The processor 314 also implements a translation module, as a software/firmware process or as a dedicated hardware circuit.

In many systems, the non-volatile memory is addressed internally to the storage system using physical addresses associated with one or more memory dies. However, the host system will use logical addresses to address the various memory locations. This enables the host to assign data to consecutive logical addresses, while the storage system is free to store the data as it wishes among the locations of the one or more memory dies. To implement this system, the memory controller 304 (e.g., the translation module) performs address translation between the logical addresses used by the host and the physical addresses used by the memory dies.

One example implementation is to maintain tables (i.e., the L2P tables referenced above) that identify the current translation between logical addresses and physical addresses. An entry in the L2P table may include an identification of a logical address and corresponding physical address. Although logical address to physical address tables (or L2P tables) include the word “tables” they need not literally be tables. Rather, the logical address to physical address tables (or L2P tables) can be any type of data structure. In some examples, the memory space of a storage system is so large that the local memory 308 cannot hold all of the L2P tables. In such a case, the entire set of L2P tables are stored in non-volatile memory 306 and a subset of the L2P tables are cached (L2P cache) in the local high speed volatile memory 308.

The ECC engine 316 performs error correction services. For example, the ECC engine 316 performs data encoding and decoding, as per an implemented ECC technique. In one embodiment, the ECC engine 316 is an electrical circuit programmed by software. For example, the ECC engine 316 can be a processor that can be programmed. In other embodiments, the ECC engine 316 is a custom and dedicated hardware circuit without any software. In another embodiment, the function of ECC engine 316 is implemented by the processor 314.

The memory interface 318 communicates with the non-volatile memory 306. In one embodiment, the memory interface provides a Toggle Mode interface. However, other interfaces also can be used. In some example implementations, the memory interface 318 (or another portion of the controller 304) implements a scheduler and buffer for transmitting data to and receiving data from one or more memory die.

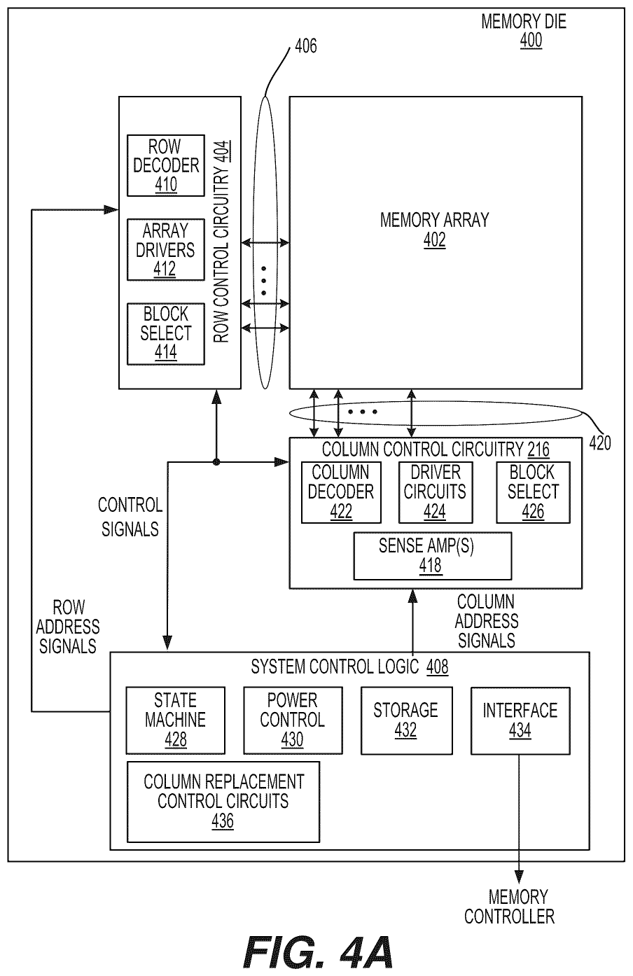

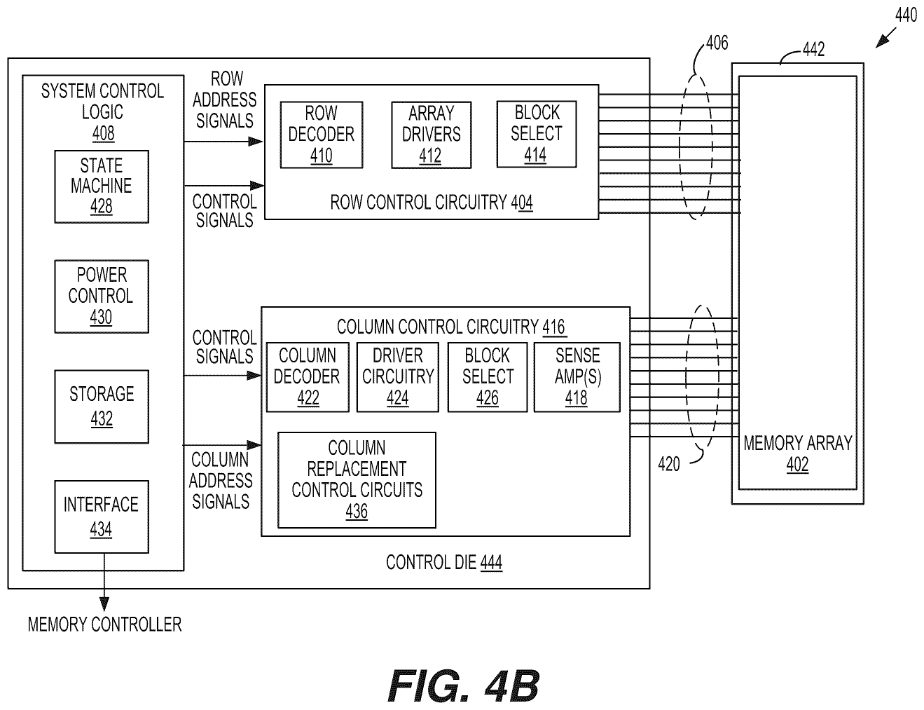

In one embodiment, the non-volatile memory 306 includes one or more memory die. FIG. 4A is a functional block diagrams of one embodiment of a memory die 400 that includes the non-volatile memory 306. Each of the one or more memory dies of non-volatile memory 306 can be implemented as the memory die 400 of FIG. 4A. The components depicted in FIG. 4A are electrical circuits.

The memory die 400 includes a memory array 402 that can include non-volatile memory cells, as described in further detail below. The memory array 402 includes a plurality of layers of word lines that are organized as rows, and a plurality of layers of bit lines that are organized as columns. However, other orientations can also be implemented. The aforementioned full-weight matrix is stored in the memory array 402.

The memory die 400 also includes row control circuitry 404, whose outputs 406 are connected to respective word lines of the memory array 402. In operation, the row control circuitry 404 receives a group of M row address signals and one or more various control signals from a system control logic circuit 408 and may include such circuits as row decoders 410, array terminal drivers 412, and block select circuitry 414 for both reading and writing (programming) operations.

The row control circuitry 404 also may include read/write circuitry. The memory die 400 also includes column control circuitry 416 including sense amplifier(s) 418 whose input/outputs 420 are connected to respective bit lines of the memory array 402. Although only a single block is shown for memory array 402, the memory die 400 can include multiple arrays that can be individually accessed.

The column control circuitry 416 receives a group of N column address signals and one or more various control signals from system control logic 408. The column control circuitry 416 may also include such circuits as column decoders 422; array terminal receivers or driver circuits 424; block select circuitry 426; read/write circuitry; and I/O multiplexers.

The system control logic 408 receives data and commands from memory controller 304 (FIG. 3) and provides output data and status to host 302 (also illustrated in FIG. 3). In some embodiments, the system control logic 408, which includes one or more electrical circuits, includes a state machine 428 that provides die-level control of memory operations. In one embodiment, the state machine 428 is programmable by software. In other embodiments, the state machine 428 does not use software and is completely implemented in hardware (e.g., electrical circuits). In another embodiment, the state machine 428 is replaced by a micro-controller or microprocessor, either on or off the memory chip.

The system control logic 408 also can include a power control module 430 that controls the power and voltages supplied to the rows and columns of memory structure 402 during memory operations and may include charge pumps and regulator circuits for creating regulating voltages. The system control logic 408 also includes storage 432 (e.g., RAM, registers, latches, etc.), which may be used to store parameters for operating memory array 402.

In operation, commands and data are transferred between the memory controller 304 (FIG. 3) and the memory die 400 via a memory controller interface 434 (also referred to as a “communication interface”). The memory controller interface 434 is an electrical interface for communicating with memory controller 304. Examples of the memory controller interface 434 include a Toggle Mode Interface and an Open NAND Flash Interface (ONFI). Other I/O interfaces can also be used in other embodiments.

In an embodiment, the system control logic 408 also includes column replacement control circuits 436, described in more detail below.

In some embodiments, all elements of the memory die 400, including the system control logic 408, can be formed as part of a single die. In other embodiments, some or all of the system control logic 408 can be formed on a different die.

In one embodiment, the memory structure 402 comprises a three-dimensional memory array of non-volatile memory cells in which multiple memory levels are formed above a single substrate, such as a wafer. The memory structure 402 may include any type of non-volatile memory that are monolithically formed in one or more physical levels of memory cells having an active area disposed above a silicon (or other type of) substrate. In one example, the non-volatile memory cells include charge-trapping layers and are arranged in a plurality of vertical NAND strings.

In another embodiment, the memory structure 402 includes a two-dimensional memory array of non-volatile memory cells. In one example, the non-volatile memory cells are NAND flash memory cells utilizing floating gates. Other types of memory cells (e.g., NOR-type flash memory) can also be used.

The exact type of memory array architecture or memory cell included in memory structure 402 is not limited to the examples above. Many different types of memory array architectures or memory technologies can be used to form memory structure 402. No particular non-volatile memory technology is required for purposes of the new claimed embodiments proposed herein. For example, suitable technologies for the memory cells of the memory structure 402 include ReRAM memories (resistive random access memories), magnetoresistive memory (e.g., MRAM, Spin Transfer Torque MRAM, Spin Orbit Torque MRAM), FeRAM, phase change memory (e.g., PCM), and the like. Examples of suitable technologies for memory cell architectures of memory structure 402 include two dimensional arrays, three dimensional arrays, cross-point arrays, stacked two dimensional arrays, vertical bit line arrays, and the like. One example of a ReRAM cross-point memory includes reversible resistance-switching elements arranged in cross-point arrays accessed by X lines and Y lines (e.g., word lines and bit lines).

In another embodiment, the memory cells may include conductive bridge memory elements. A conductive bridge memory element may also be referred to as a programmable metallization cell. A conductive bridge memory element may be used as a state change element based on the physical relocation of ions within a solid electrolyte. In some cases, a conductive bridge memory element may include two solid metal electrodes, one relatively inert (e.g., tungsten) and the other electrochemically active (e.g., silver or copper), with a thin film of the solid electrolyte between the two electrodes. As temperature increases, the mobility of the ions also increases causing the programming threshold for the conductive bridge memory cell to decrease. Thus, the conductive bridge memory element may have a wide range of programming thresholds over temperature.

Another example is magnetoresistive random access memory (MRAM) that stores data by magnetic storage elements. The elements are formed from two ferromagnetic layers, each of which can hold a magnetization, and the ferromagnetic layers are separated by a thin insulating layer. One of the two ferromagnetic layers is a permanent magnet that is set to a particular polarity, and the other ferromagnetic layer's magnetization can be changed to match that of an external field to store memory. The memory array may be built from a grid of such memory cells. In one embodiment, for programming, each memory cell lies between a pair of write lines that are arranged at right angles to each other, parallel to the cell, one above and one below the cell. When current is passed through the write lines, an induced magnetic field is created. MRAM based memory embodiments will be discussed in more detail below.

Phase change memory (PCM) exploits the unique behavior of chalcogenide glass. One embodiment uses a GeTe—Sb₂Te₃ super lattice to achieve non-thermal phase changes by simply changing the co-ordination state of the Germanium atoms with a laser pulse (or light pulse from another source). Therefore, the doses of programming are laser pulses. The memory cells can be inhibited by blocking the memory cells from receiving the light. In other PCM embodiments, the memory cells are programmed by current pulses. Note that the use of “pulse” in this document does not require a square pulse but includes a (continuous or non-continuous) vibration or burst of sound, current, voltage light, or another wave. These memory elements within the individual selectable memory cells, or bits, may include a further series element that is a selector, such as an ovonic threshold switch or metal insulator substrate.

The technology described herein is not limited to a single specific memory structure, memory construction or material composition, but covers many relevant memory structures within the spirit and scope of the technology as described herein and as understood by one of ordinary skill in the art.

The elements of FIG. 4A can be grouped into two parts: (1) the memory structure/array 402 and (2) peripheral circuitry, which includes all of the other components depicted in FIG. 4A. An important characteristic of a memory circuit is its capacity, which can be increased by increasing the area of the memory die of storage system 300 (FIG. 3) that is given over to the memory structure/array 402. However, this reduces the area of the memory die available for the peripheral circuitry. This can place quite severe restrictions on these elements of the peripheral circuitry. For example, the need to fit sense amplifier circuits within the available area can be a significant restriction on sense amplifier design architectures. With respect to system control logic 408, reduced availability of area can limit the available functions that can be implemented on-chip. Consequently, a basic trade-off in the design of a memory die for the storage system 300 may be the amount of area to devote to the memory structure 402 and the amount of area to devote to the peripheral circuitry.

Another area in which the memory structure 402 and the peripheral circuitry are often at odds is in the processing involved in forming these regions, since these regions often involve differing processing technologies and the trade-off in having differing technologies on a single die. For example, when the memory structure 402 is NAND flash, this is an NMOS structure, while the peripheral circuitry is often CMOS based.

Elements such as the sense amplifier circuits, charge pumps, logic elements in a state machine, and other peripheral circuitry in the system control logic 408 often employ PMOS devices. Processing operations for manufacturing a CMOS die will differ in many aspects from the processing operations optimized for an NMOS flash NAND memory or other memory cell technologies.

To improve upon these limitations, embodiments described below can separate the elements of FIG. 4A onto a separately formed die that is then bonded together with another die. More specifically, the memory structure/array 402 can be formed on one die (referred to as the memory die) and some or all of the peripheral circuitry elements, including one or more control circuits, can be formed on a separate die (referred to as the control die). A memory die can be formed of just the memory elements, such as the array of memory cells of flash NAND memory, MRAM memory, PCM memory, ReRAM memory, or other memory type. Some or all of the peripheral circuitry, even including elements such as decoders and sense amplifiers, can then be moved on to a separate control die. This allows each of the memory die to be optimized individually according to its technology.

For example, a NAND memory die can be optimized for an NMOS based memory array structure, without worrying about the CMOS elements that have now been moved onto a control die that can be optimized for CMOS processing. This allows more space for the peripheral elements, which can now incorporate additional capabilities that could not be readily incorporated were they restricted to the margins of the same die holding the memory cell array.

The two die can then be bonded together in a bonded multi-die memory circuit, with the array on the one die connected to the periphery elements on the other die. Although the following will focus on a bonded memory circuit of one memory die and one control die, other embodiments can use more die, such as two memory die and one control die, for example.

FIG. 4B shows an alternative arrangement to that of FIG. 4A which may be implemented using wafer-to-wafer bonding to provide a bonded die pair. FIG. 4B depicts a functional block diagram of one embodiment of an integrated memory assembly 440. One or more integrated memory assemblies 440 may be used to implement the non-volatile memory 306 (FIG. 3) of storage system 300 (also FIG. 3).

The integrated memory assembly 440 includes two types of semiconductor die (or more succinctly, “die”). The memory die 442 includes the memory structure/array 402 with the non-volatile memory cells. A control die 444 includes control circuitry 404, 408, 416 (as described above). In some embodiments, the control die 444 is configured to connect to the memory structure/array 402 in the memory die 442. In some embodiments, the memory die 442 and control die 444 are bonded together.

FIG. 4B shows an example of the peripheral circuitry, including control circuits, formed in a peripheral circuit or control die 444 coupled to memory structure/array 402 formed in memory die 442. Common components are labelled similarly to FIG. 4A. The system control logic 408, the row control circuitry 404, and the column control circuitry 416 are located in the control die 444. In some embodiments, all or a portion of column control circuitry 416 and all or a portion of the row control circuitry 404 are located on memory die 442. In some embodiments, some of the circuitry in the system control logic 408 is located on the memory die 442.

The system control logic 408, the row control circuitry 204, and the column control circuitry 416 may be formed by a common process (e.g., CMOS process), so that adding elements and functions, such as the ECC controller, more typically found on a memory controller 304 (FIG. 3) may require few or no additional process steps, i.e., the same process steps used to fabricate controller 304 may also be used to fabricate the system control logic 408, the row control circuitry 404, and the column control circuitry 416.

Thus, while moving such circuits from a die such as the memory die 442 may reduce the number of steps needed to fabricate such a die, adding such circuits to a die such as control die 444 may not require many additional process steps. The control die 444 also could be referred to as a CMOS die, due to the use of CMOS technology to implement some or all of the control circuitry 404, 408, 416.

FIG. 4B shows column control circuitry 416, including the sense amplifier(s) 418, on control die 444 coupled to memory structure/array 402 on memory die 442 through electrical paths 420. The electrical paths 420 may provide an electrical connection between the column decoder 422, the driver circuitry 424, the block select 426, and the bit lines of the memory structure/array 402. In an embodiment, the column control circuitry 416 also includes column replacement control circuits 436, which are described in more detail below.

Electrical paths may extend from the column control circuitry 416 in the control die 444 through pads on the control die 444 that are bonded to corresponding pads of the memory die 442, which are connected to the bit lines of the memory structure 402. Each bit line of the memory structure 402 may have a corresponding one of the electrical paths 420, including a pair of bond pads, which connects to the column control circuitry 416.

Similarly, the row control circuitry 404, including the row decoder 410, the array drivers 412, and the block select 414 are coupled to the memory structure 402 through electrical paths 406. Each of the electrical paths 406 may correspond to a data containing word line, a dummy word line, or a select gate line. Additional electrical paths may also be provided between control die 444 and memory die 442.

For purposes of this document, the phrases “a control circuit,” “control circuitry,” or “one or more control circuits” can include any one of or any combination of the memory controller 304 (FIG. 3); the state machine 428; all or a portion of the system control logic 408; all or a portion of row control circuitry 404; all or a portion of column control circuitry 416; a microcontroller; a microprocessor; and/or other similar functioned circuits.

The control circuit can include hardware only or a combination of hardware and software (including firmware). For example, one or more controllers programmed by firmware to perform the functions described herein is one example of a control circuit. A control circuit can include a processor, FGA, ASIC, integrated circuit, or other type of circuit.

In some embodiments, there is more than one control die 444 and more than one memory die 442 in an integrated memory assembly 440. In some embodiments, the integrated memory assembly 440 includes a stack of multiple control dies 444 and multiple memory dies 442.

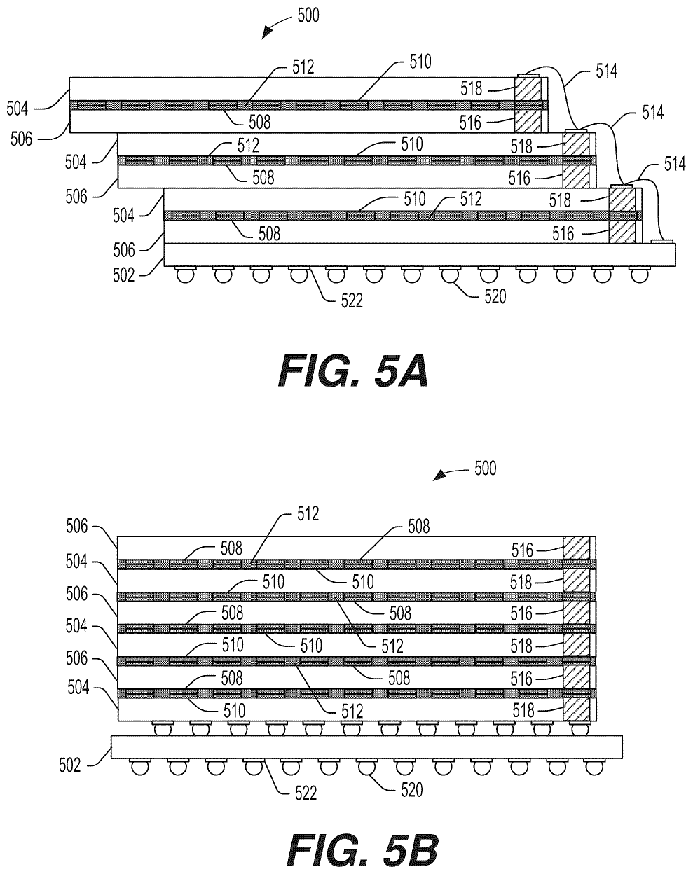

FIG. 5A depicts a side view of an embodiment of an integrated memory assembly 500 stacked on a substrate 502 (e.g., a stack including control die 504 and memory die 506). In this embodiment, the integrated memory assembly 500 has three control die 504 and three memory die 506. In some embodiments, there are more than three memory die 506 and more than three control die 504.

Each control die 504 is affixed (e.g., bonded) to at least one memory die 506. Some of the bond pads 508/510 are depicted, although there may be many more bond pads. A space between two die 504, 506 that are bonded together is filled with a solid layer 512, which may be formed from epoxy or other resin or polymer. This solid layer 512 protects the electrical connections between the die 506, 504 and further secures the die together. Various materials may be used as solid layer 512, but in some embodiments, it may be Hysol epoxy resin from Henkel Corp., having offices in California, USA.

Integrated memory assembly 500 may for example be stacked with a stepped offset, leaving the bond pads at each level uncovered and accessible from above. Wire bonds 514 connected to the bond pads connect control die 504 to substrate 502. A number of such wire bonds may be formed across the width of each control die 504 (i.e., into the page of FIG. 5A).

A memory die through silicon via (TSV) 516 may be used to route signals through each memory die 506. A control die TSV 518 may be used to route signals through each control die 504. The TSVs 516, 518 may be formed before, during or after formation of the integrated circuits in semiconductor die 506, 504. The TSVs may be formed by etching holes through the wafers. The holes may then be lined with a barrier against metal diffusion. The barrier layer may in turn be lined with a seed layer, and the seed layer may be plated with an electrical conductor such as copper, although other suitable materials such as aluminum, tin, nickel, gold, doped polysilicon, and alloys or combinations thereof may be used.

Solder balls 520 optionally may be affixed to contact pads 522 on a lower surface of substrate 502. Solder balls 520 may be used to couple integrated memory assembly 500 electrically and mechanically to a host device such as a printed circuit board. Solder balls 520 may be omitted where the integrated memory assembly 500 is to be used as an LGA package. Solder balls 520 may form a part of an interface between integrated memory assembly 500 and memory controller 304 (FIG. 3).

FIG. 5B depicts a side view of another embodiment of an integrated memory assembly 500 stacked on a substrate 502. The integrated memory assembly 500 of FIG. 5B has three control die 504 and three memory die 506. In some embodiments, there are many more than three memory die 506 and many more than three control die 504. In this example, each control die 504 is bonded to at least one memory die 506. Optionally, a control die 504 may be bonded to two or more memory die 506.

Some of the bond pads 508, 510 are depicted, but there may be many more bond pads than are illustrated. A space between two die 506, 504 that are bonded together is filled with a solid layer 512, which may be formed from epoxy or other resin or polymer. In contrast to the example in FIG. 5A, the integrated memory assembly 500 of FIG. 5B does not have a stepped offset. A memory die TSV 516 may be used to route signals through each memory die 506. A control die TSV 518 may be used to route signals through each control die 504.

As has been briefly discussed above, the control die 504 and the memory die 506 may be bonded together. Bond pads on each control die 504 and each memory die 506 may be used to bond the two die together. In some embodiments, the bond pads are bonded directly to each other, without solder or other added material, in a so-called Cu-to-Cu bonding process. In a Cu-to-Cu bonding process, the bond pads are controlled to be highly planar and formed in a highly controlled environment largely devoid of ambient particulates that might otherwise settle on a bond pad and prevent a close bond. Under such properly controlled conditions, the bond pads are aligned and pressed against each other to form a mutual bond based on surface tension. Such bonds may be formed at room temperature, though heat also may be applied. In embodiments using cu-to-cu bonding, the bond pads may be about 5 μm square and spaced from each other with a pitch of 5 μm to 5 μm. Although this process is referred to herein as cu-to-cu bonding, this term also may apply even where the bond pads are formed of materials other than copper. When the area of bond pads is small, it may be difficult to bond the semiconductor die together. The size of and pitch between bond pads may be further reduced by providing a film layer on the surfaces of the semiconductor die including the bond pads. The film layer is provided around the bond pads. When the die are brought together, the bond pads may bond to each other, and the film layers on the respective die may bond to each other. Such a bonding technique may be referred to as hybrid bonding. In embodiments using hybrid bonding, the bond pads may be about 5 μm square and spaced from each other with a pitch of 1 μm to 5 μm. Bonding techniques may be used providing bond pads with even smaller (or greater) sizes and pitches.

Some embodiments may include a film on a surface of the control die 504 and the memory die 506. Where no such film is initially provided, a space between the die may be under filled with an epoxy or other resin or polymer. The under-fill material may be applied as a liquid which then hardens into a solid layer. This under-fill step protects the electrical connections between control die 504 and memory die 506, and further secures the die together. Various materials may be used as under-fill material, such as Hysol epoxy resin from Henkel Corp., having offices in California, USA.

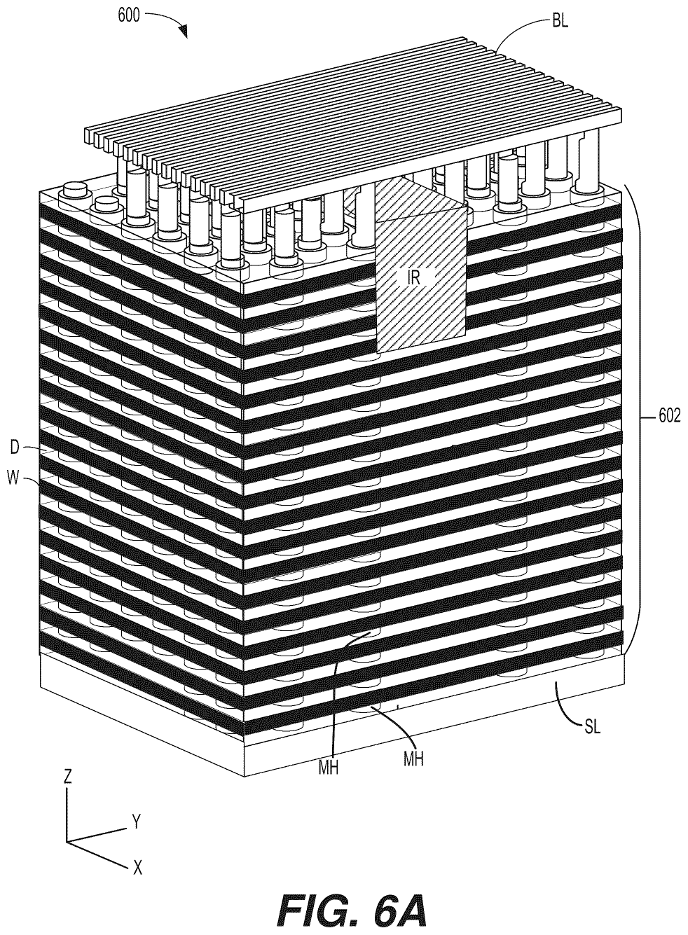

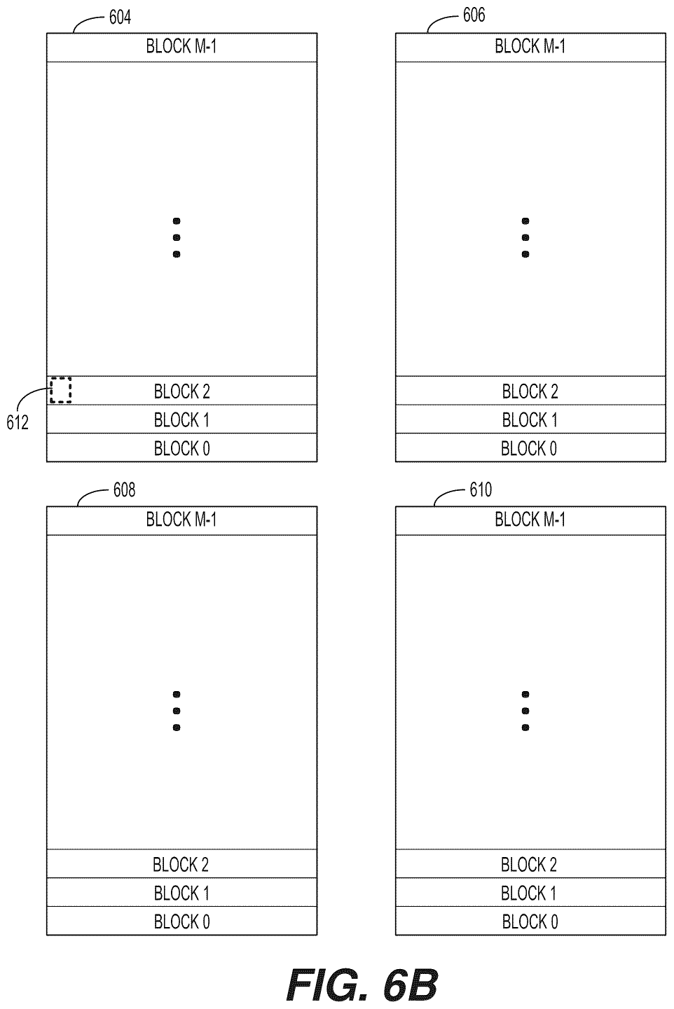

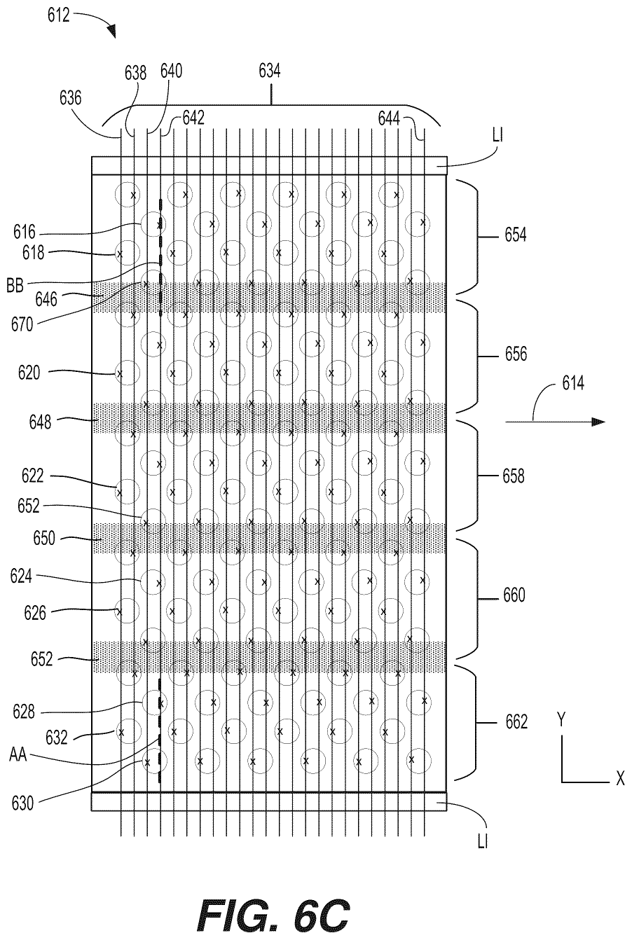

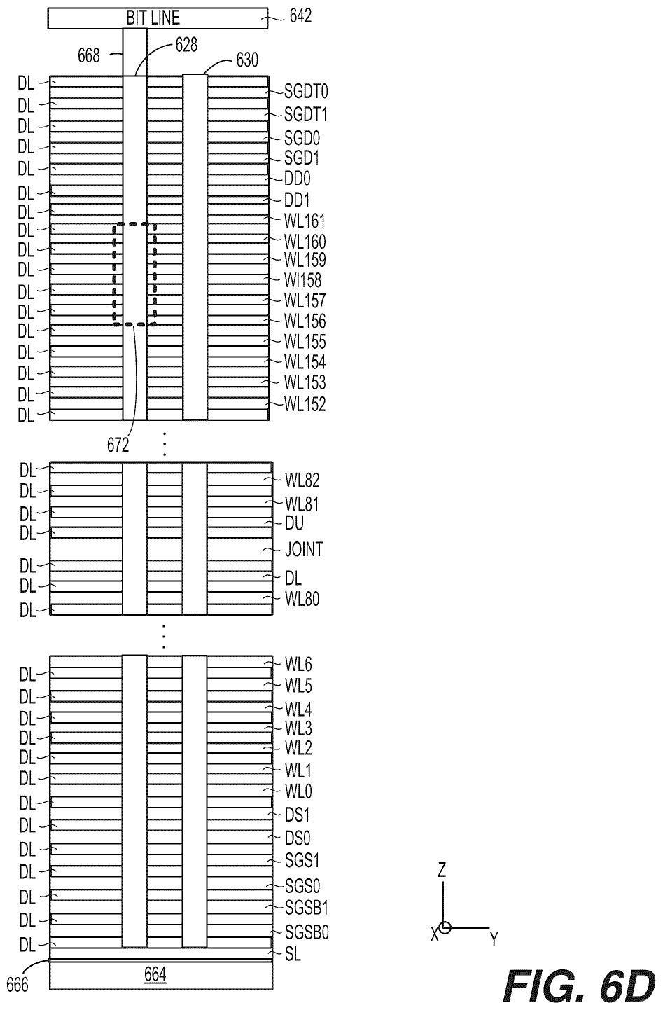

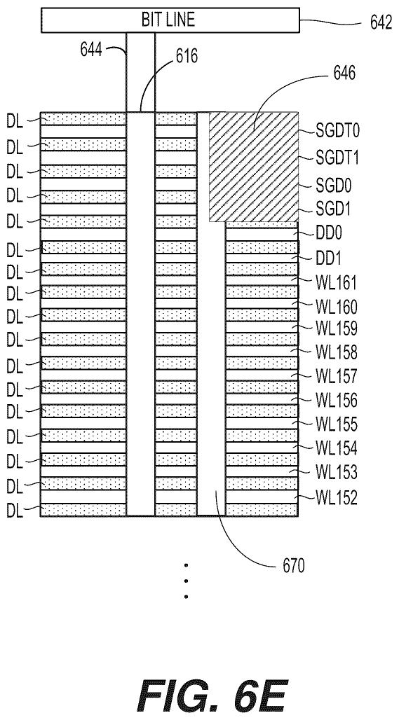

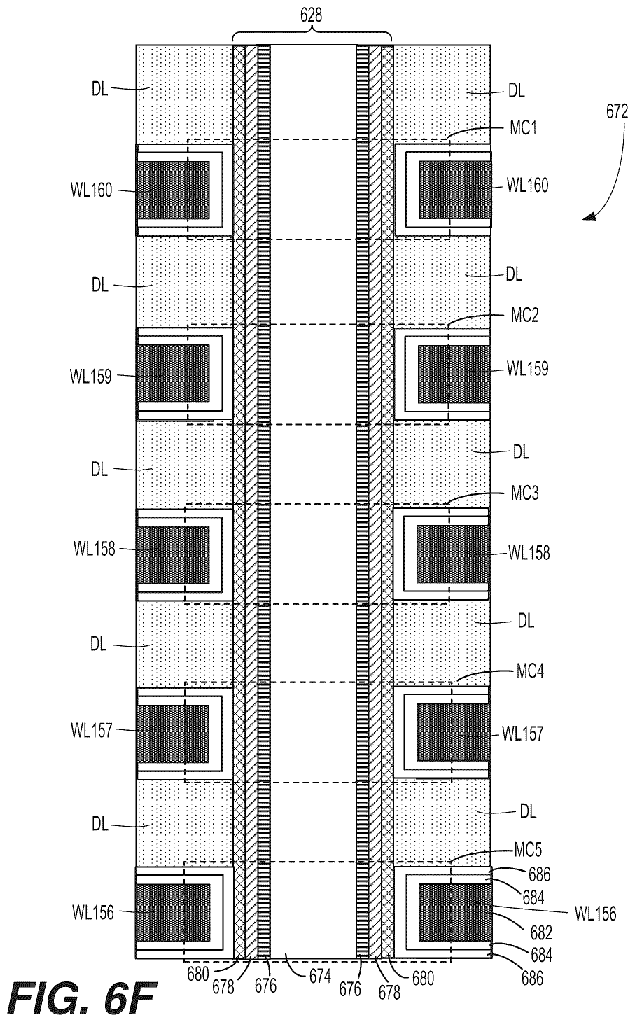

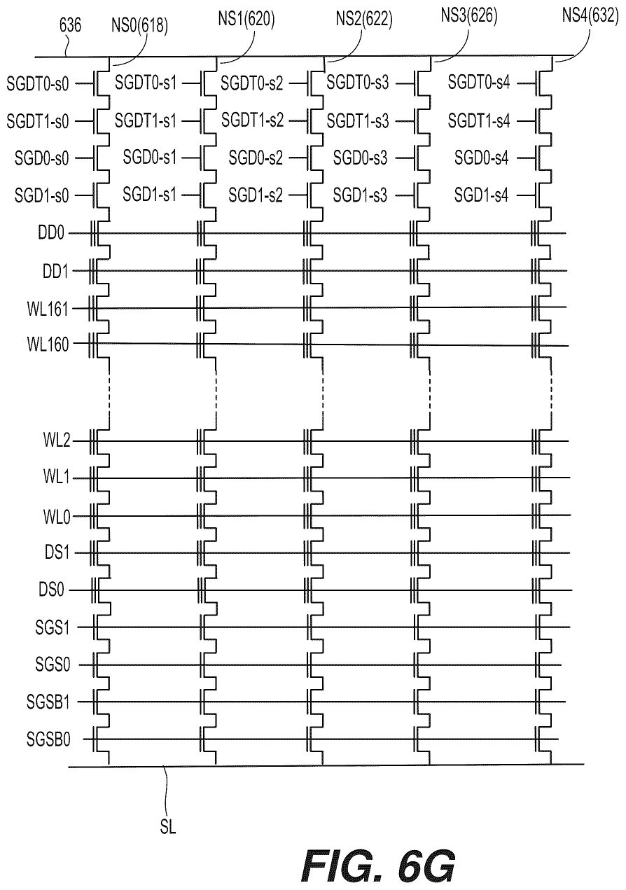

FIG. 6A is a perspective view of a portion of one example embodiment of a monolithic three dimensional memory array/structure included in memory structure 202, which includes a plurality non-volatile memory cells arranged as vertical NAND strings. For example, FIG. 6A shows a portion 600 of one block of memory. The structure depicted includes a set of bit lines BL positioned above a stack 602 of alternating dielectric layers and conductive layers. For example purposes, one of the dielectric layers is marked as D and one of the conductive layers (also called word line layers) is marked as W. The number of alternating dielectric layers and conductive layers can vary based on specific implementation requirements.

As will be explained below, in one embodiment the alternating dielectric layers and conductive layers are divided into, for example, four or five (or a different number of) regions by isolation regions IR. FIG. 6A shows one isolation region IR separating two regions. Below the alternating dielectric layers and word line layers is a common source line layer SL. Memory holes are formed in the stack of alternating dielectric layers and conductive layers. For example, one of the memory holes is marked as MH. Note that in FIG. 6A, the dielectric layers are depicted as see-through so that the reader can see the memory holes positioned in the stack of alternating dielectric layers and conductive layers. In one embodiment, NAND strings are formed by filling the memory hole with materials including a charge-trapping material to create a vertical column of memory cells.

Thus, the non-volatile memory cells are arranged in memory holes, and each memory cell can store one or more bits of data, e.g., up to five bits of data per memory cell. More details of the three dimensional monolithic memory array that comprises memory structure 202 is provided below.

FIG. 6B is a block diagram explaining one example organization of memory structure 202, which is divided into four planes 604, 606, 608 and 610. Each plane is then divided into M blocks. In one example, each plane has about 2,000 blocks (“Block 0” to “Block M−1” with M being 2,000). However, different numbers of blocks and planes can also be used.

In one embodiment, a block of memory cells is a unit of erase. That is, all memory cells of a block are erased together. In other embodiments, the blocks can be divided into sub-blocks, each of which includes a plurality of word lines, and the sub-blocks can be the unit of erase. Memory cells also can be grouped into blocks for other reasons, such as to organize the memory structure to enable the signaling and selection circuits.

In some embodiments, a block represents a groups of connected memory cells as the memory cells of a block share a common set of word lines. For example, the word lines for a block are all connected to all of the vertical NAND strings for that respective block. Although FIG. 6B shows four planes, more or fewer than four planes can be implemented. In some embodiments, the memory structure 202 includes eight planes.

Each block typically is divided into one or more pages, with each page being a unit of programming/writing and a unit of reading. Other units of programming also can be used. In an embodiment, one or more pages of data are typically stored in one row of memory cells. For example, one or more pages of data may be stored in memory cells connected to a common word line. In an embodiment, a page includes data stored in all memory cells connected to a common word line within the block.

FIGS. 6C-6G depict an example three dimensional (“3D”) NAND structure that corresponds to the structure of FIG. 6A and can be used to implement the memory structure 202 of FIGS. 2A and 2B. FIG. 6C is a block diagram that depicts a top view of a portion 612 of Block 2 of plane 604. As can be seen from FIG. 6C, the block depicted in FIG. 6C extends in the direction of 614. In one embodiment, the memory array has many such layers with only the top layer being illustrated in FIG. 6C.

FIG. 6C depicts a plurality of circles that represent the memory holes, which are also referred to as vertical columns. Each of the memory holes/vertical columns includes multiple select transistors (also referred to as a select gate or selection gate) and multiple memory cells. In one embodiment, each memory hole/vertical column implements a NAND string. For example, FIG. 6C labels a subset of the memory holes/vertical columns/NAND strings 616, 618, 620, 622, 624, 626, 628, 630, and 632.

FIG. 6C also depicts a set of bit lines 634, including bit lines 636, 638, 640, 642, . . . 644. FIG. 6C shows twenty four bit lines because only a portion of the block is depicted. It is contemplated that more than twenty four bit lines connected to memory holes/vertical columns of the block. Each of the circles representing memory holes/vertical columns has an “x” to indicate its connection to one of the bit lines. For example, bit line 636 is connected to the memory holes/vertical columns 618, 620, 622, 626, and 632.

The block depicted in FIG. 6C includes a set of isolation regions 646, 648, 650 and 652, which are formed of SiO₂. However, other dielectric materials also can be used. Isolation regions 646, 648, 650, and 652 serve to divide the top layers of the block into five regions. For example, the top layer depicted in FIG. 6C is divided into regions 654, 656, 658, 660, and 662.

In one embodiment, the isolation regions only divide the layers used to implement select gates so that NAND strings in different regions can be independently selected. In one example implementation, a bit line connects to one memory hole/vertical column/NAND string in each of regions 654, 656, 658, 660, and 662. In that implementation, each block has twenty four rows of active columns and each bit line connects to five rows in each block.

In one embodiment, all of the five memory holes/vertical columns/NAND strings connected to a common bit line are connected to the same set of word lines; therefore, the system uses the drain side selection lines to choose one (or another subset) of the five to be subjected to a memory operation (program, verify, read, and/or erase). FIG. 6C also shows Line Interconnects LI, which are metal connections to the source line SL from above the memory array. Line Interconnects LI are positioned adjacent regions 654 and 662.

Although FIG. 6C shows each region 654, 656, 658, 660, and 662 as having four rows of memory holes/vertical columns, five regions and twenty four rows of memory holes/vertical columns in a block, those exact numbers are an example implementation. Other embodiments may include more or fewer regions per block; more or fewer rows of memory holes/vertical columns per region; and more or fewer rows of vertical columns per block.

FIG. 6C also shows the memory holes/vertical columns being staggered. In other embodiments, different patterns of staggering can be used. In some embodiments, the memory holes/vertical columns are not staggered.

FIG. 6D depicts a portion of one embodiment of a three dimensional memory structure 202 showing a cross-sectional view along line AA of FIG. 6C. This cross sectional view cuts through memory holes/vertical columns (NAND strings) 628 and 630 of region 662 (see FIG. 6C).

The structure of FIG. 6D includes two drain side select layers SGD0 and SGD1; two source side select layers SGS0 and SGS1; two drain side GIDL generation transistor layers SGDT0 and SGDT1; two source side GIDL generation transistor layers SGSB0 and SGSB1; two drain side dummy word line layers DD0 and DD1; two source side dummy word line layers DS0 and DS1; dummy word line layers DU and DL that are separated by a joint; one hundred and sixty two word line layers WL0-WL161 for connecting to data memory cells; and dielectric layers DL. Other embodiments can implement more or fewer than the numbers described above for FIG. 6D. In one embodiment, SGD0 and SGD1 are connected together and SGS0 and SGS1 are connected together. In other embodiments, more or fewer SGDs (greater or lesser than two) are connected together and more or fewer SGS devices (greater or lesser than two) are connected together.

In one embodiment, erasing the memory cells is performed using gate induced drain leakage (GIDL), which includes generating charge carriers at the GIDL generation transistors such that the carriers get injected into the charge trapping layers of the NAND strings to change (reduce) respective threshold voltages Vt of the memory cells. In the embodiment of FIG. 6D, there are two GIDL generation transistors at each end of the NAND string; however, in other embodiments there are more or fewer than two GIDL generation transistors.

Embodiments that use GIDL at both sides of the NAND string may have GIDL generation transistors at both sides. Embodiments that use GIDL at only the drain side of the NAND string may have GIDL generation transistors only at the drain side. Embodiments that use GIDL at only the source side of the NAND string may have GIDL generation transistors only at the source side.

The GIDL generation transistors have an abrupt PN junction to generate the charge carriers for GIDL and, during fabrication, a phosphorous diffusion is performed at the polysilicon channel of the GIDL generation transistors. In some cases, the GIDL generation transistor with the shallowest phosphorous diffusion is the GIDL generation transistor that generates the charge carriers during erase. However, in some embodiments charge carriers can be generated by GIDL at multiple GIDL generation transistors at a particular side of the NAND string.

The memory holes/vertical columns 628, 630 are depicted protruding through the drain side select layers, source side select layers, dummy word line layers, GIDL generation transistor layers and word line layers. In one embodiment, each memory hole/vertical column comprises a vertical NAND string. Below the memory holes/vertical columns and the layers listed below is substrate 664, an insulating film 666 on the substrate, and source line SL. The NAND string of memory hole/vertical column 628 has a source end at a bottom of the stack and a drain end at a top of the stack. As in agreement with FIG. 6C, FIG. 6D show vertical memory hole/column 628 connected to bit line 642 via connector 668.

For ease of reference, drain side select layers, source side select layers, dummy word line layers, GIDL generation transistor layers and data word line layers collectively are referred to as conductive layers.

In one embodiment, the conductive layers are made from a combination of TiN and Tungsten. In other embodiments, other materials can be used to form the conductive layers, such as doped polysilicon, metal such as Tungsten, metal silicide, such as nickel silicide, tungsten silicide, aluminum silicide or the combination thereof.

In some embodiments, different conductive layers can be formed from different materials. Between conductive layers are dielectric layers DL. In one embodiment, the dielectric layers are made from SiO₂. In other embodiments, other dielectric materials can be used to form the dielectric layers.

The non-volatile memory cells are formed along memory holes/vertical columns which extend through alternating conductive and dielectric layers in the stack. In one embodiment, the memory cells are arranged in NAND strings. The word line layers WL0-W161 connect to memory cells (also called data memory cells). The dummy word line layers connect to a plurality of dummy memory cells, which do not store data. In some embodiments, the data memory cells and the dummy memory cells may have a same structure. The drain side select layers SGD0 and SGD1 are used to electrically connect and disconnect the NAND strings to and from the bit lines. The source side select layers SGS0 and SGS1 are used to electrically connect and disconnect the NAND strings to and from the source line SL.

FIG. 6D shows that the memory array is implemented as a two tier architecture, with the tiers separated by a joint area. In one embodiment, it is expensive and/or challenging to etch so many word line layers intermixed with dielectric layers. To ease this burden, a first stack of word line layers (e.g., WL0-WL80) are laid down with alternating dielectric layers, then the Joint area is laid down, and next, a second stack of word line layers (e.g., WL81-WL161) are laid down with alternating dielectric layers. The joint area is thus positioned between the first stack of word line layers and the second stack of word line layers. In one embodiment, the joint areas are made from the same materials as the word line layers. In other embodiments, there can no joint area or there can be multiple joint areas.

FIG. 6E depicts a portion of one embodiment of a three dimensional memory structure 202 showing a cross-sectional view along line BB of FIG. 6C. This cross sectional view cuts through memory holes/vertical columns (NAND strings) 616 and 670 of region 654 (see FIG. 6C). FIG. 6E shows the same alternating conductive and dielectric layers as FIG. 6D.

FIG. 6E also shows isolation region 646, which occupies a space that would have been used for a portion of the memory holes/vertical columns/NAND stings, including a space that would have been used for a portion of memory hole/vertical column 670. More specifically, a portion (e.g., half the diameter) of vertical column 670 has been removed in layers SGDT0, SGDT1, SGD0, and SGD1 to accommodate isolation region 646. Thus, while most of the vertical column 670 is cylindrical (has a circular cross section), the portion of vertical column 670 in layers SGDT0, SGDT1, SGD0, and SGD1 has a semi-circular cross section. In one embodiment, after the stack of alternating conductive and dielectric layers is formed, the stack is etched to create space for the isolation region and that space is then filled in with SiO₂. This structure allows for separate control of SGDT0, SGDT1, SGD0, and SGD1 for regions 654, 656, 658, 660, and 662 (illustrated in FIG. 6C).

FIG. 6F depicts a cross sectional view of region 672 of FIG. 6D that includes a portion of memory hole/vertical column 628. In one embodiment, the memory holes/vertical columns are round. However, in other embodiments other shapes can be used. In one embodiment, memory hole/vertical column 628 includes an inner core layer 674 that is made of a dielectric, such as SiO₂. Surrounding the inner core 674 is a polysilicon channel 676 (materials other than polysilicon can alternately be used). The channel 676 extends between and is connected with the bit line and the source line. Surrounding the channel 676 is a tunneling dielectric 678 layer, which may have an ONO structure. Surrounding the tunneling dielectric 678 layer is charge trapping layer 680, which may be formed of, for example, Silicon Nitride. It should be appreciated that the technology described herein is not limited to any particular material or structure.

FIG. 6F depicts the dielectric layers DL as well as the word line layers WL160, WL159, WL158, WL157, and WL156. Each of these word line layers includes a word line region 682 surrounded by an aluminum oxide layer 684, which is surrounded by a blocking oxide layer 686. In other embodiments, the blocking oxide layer 686 can be a vertical layer that is parallel with and adjacent to the charge trapping layer 680. The physical interaction of the word line layers with the vertical column forms the memory cells of the NAND string. Thus, in one embodiment a memory cell includes the channel 676, the tunneling dielectric 678, the charge trapping layer 680, the blocking oxide layer 686, the aluminum oxide layer 684, and the word line region 682. For example, word line layer WL160 and a portion of memory hole/vertical column 628 comprise a memory cell MC1. Word line layer WL159 and a portion of memory hole/vertical column 628 comprise a memory cell MC2. Word line layer WL158 and a portion of memory hole/vertical column 628 comprise a memory cell MC3. Word line layer WL157 and a portion of memory hole/vertical column 628 comprise a memory cell MC4. Word line layer WL156 and a portion of memory hole/vertical column 628 comprise a memory cell MC5. In other architectures, a memory cell may have a different structure; however, the memory cell would still be the storage unit.

When a memory cell is programmed, electrons are stored in a portion of the charge trapping layer 680 which is associated with (e.g. in) the memory cell. These electrons are drawn into the charge trapping layer 680 from the channel 676, through the tunneling dielectric 678, in response to an appropriate voltage on word line region 682. The threshold voltage (Vth) of a memory cell is increased in proportion to the amount of stored charge.

In one embodiment, the programming is achieved through Fowler-Nordheim tunneling of the electrons into the charge trapping layer 680. During an erase operation, the electrons return to the channel 676 or holes are injected into the charge trapping layer 680 to recombine with electrons. In one embodiment, erasing is achieved using hole injection into the charge trapping layer 680 via a physical mechanism such as GIDL, as described above.

FIG. 6G is a schematic diagram of a portion of the three dimensional memory array depicted in in FIGS. 6B-6F. FIG. 6G shows physical data word lines WL0-WL161 running across the entire block. The structure of FIG. 6G corresponds to a portion 612 in Block 2 of FIG. 6B, including bit line 636. Within the block, in one embodiment, each bit line is connected to five NAND strings, one in each region of regions 654, 656, 658, 660, 662 (illustrated in FIG. 6C).

Thus, FIG. 6G shows a bit line 636 connected to NAND string NS0 (which corresponds to memory hole/vertical column 618 of region 654), NAND string NS1 (which corresponds to memory hole/vertical column 620 of region 656), NAND string NS2 (which corresponds to vertical column 622 of region 658), NAND string NS3 (which corresponds to memory hole/vertical column 626 of region 660), and NAND string NS4 (which corresponds to memory hole/vertical column 632 of region 662). The drain side select line/layer SGD0 is separated by isolation regions isolation regions 646, 648, 650 and 652 to form SGD0-s0, SGD0-s1, SGD0-s2, SGD0-s3 and SGD0-s4 in order to separately connect to and independently control regions 654, 656, 658, 660, 662.

Similarly, the drain side select line/layer SGD1 is separated by isolation regions 646, 648, 650, and 652 (illustrated in FIG. 6C) to form SGD1-s0, SGD1-s1, SGD1-s2, SGD1-s3 and SGD1-s4 in order to separately connect to and independently control regions 654, 656, 658, 660, 662 (illustrated in FIG. 6C). The drain side GIDL generation transistor control line/layer SGDT0 is also separated by isolation regions 646, 648, 650 and 652 to form SGDT0-s0, SGDT0-s1, SGDT0-s2, SGDT0-s3 and SGDT0-s4 in order to separately connect to and independently control regions 654, 656, 458, 660, 662. Further, the drain side GIDL generation transistor control line/layer SGDT1 is separated by isolation regions 646, 648, 650 and 652 to form SGDT1-s0, SGDT1-s1, SGDT1-s2, SGDT1-s3 and SGDT1-s4 in order to separately connect to and independently control regions 654, 656, 658, 660, 662.

FIG. 6G only shows NAND strings connected to bit line 636. However, a full schematic of the block would show every bit line and five vertical NAND strings, which are in separate regions, connected to each bit line.

Although the example memories of FIGS. 6B-6G are three dimensional memory structures that include vertical NAND strings with charge-trapping material, other (2D and 3D) memory structures can also be used with the technology described herein.

As described above, in some machine learning applications, large language models that include a terabyte (or more) of data must be stored in memory and retrieved at a very high data rate. Such applications, which require the HBF units 26 (FIGS. 1 and 2) to operate at a very high bandwidth and with very low power consumption. In an example embodiment, the HBF units 26 achieve a bandwidth of 3 TB/s and have a power efficiency of approximately 1 pJ/bit. Technology that provides the HBF units 26 with such high bandwidth and low power consumption is discussed as follows.

During inferencing, the LLM data of the full-weight matrix 200 (shown in FIG. 2) stored in the HBF units 26 is repeatedly read, but remains fairly static. That is, once the model data have been stored in memory, the model data are not updated or changed very often, e.g., only after each LoRA instance.

NAND memory devices include memory cells that typically can be operated to store 1 bit per memory cell (sometimes referred to as “single level cell” or “SLC” memory) or multiple bits per memory cell (sometimes referred to as “multi-level cell” or “MLC” memory). SLC memory is the fastest solution for reducing read latency (and increasing bandwidth). So the remaining discussion describes HBF units 26 that operate using SLC memory cells.

In embodiments, the bandwidth of HBF memory is increased by: (1) increasing the number of memory planes per memory die, (2) increasing the number of input/output (I/O) per memory die to accommodate the increased bandwidth of the memory die, and (3) reducing the physical page size to decrease read latency. These are discussed below.

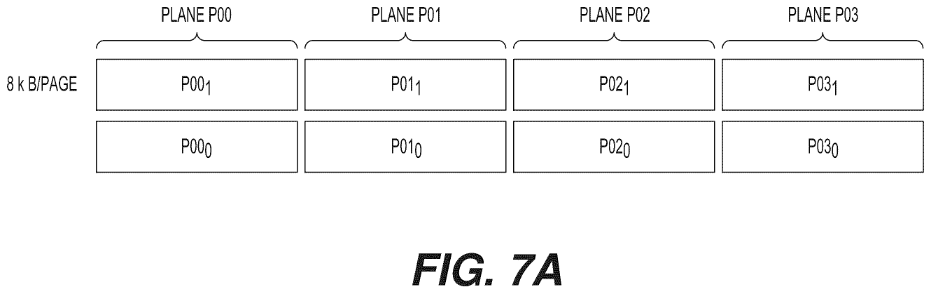

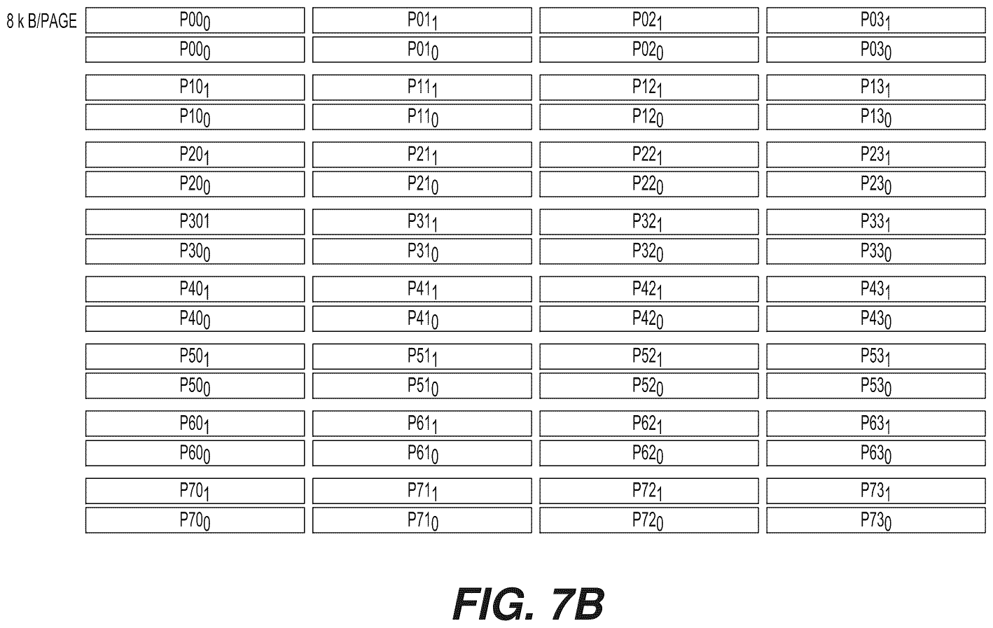

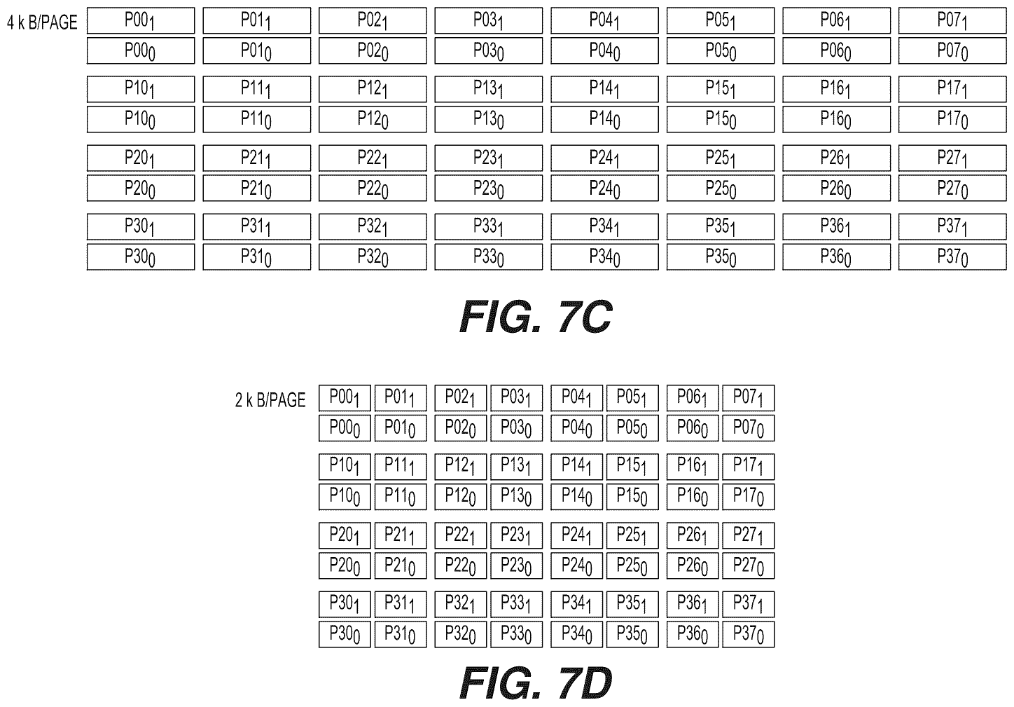

As described above, a memory structure (such as memory structure 402 of FIG. 4A) may include multiple planes, and each plane may operate in parallel. For example, FIG. 7A is a diagram depicting a memory structure that includes four planes: P00, P01, P02 and P03.

In an embodiment, each of planes P00, P01, P02 and P03 is divided into two sub-planes. For example, plane P00 includes a first sub-plane P00₀ and a second sub-plane P001, second sub-plane P01 includes a first sub-plane P01₀ and a second sub-plane P01₁, third sub-plane P02 includes a first sub-plane P02₀ and a second sub-plane P02₁, and fourth sub-plane P03 includes a first sub-plane P03₀ and a second sub-plane P03₁.

In an embodiment, each of planes P00, P01, P02 and P03 includes a logical page and a physical page size. In the embodiment of FIG. 7A, the physical page size is 8 kB/page, and each logical page includes two physical pages (i.e., 16 kB per logical page).

In an embodiment, a memory die that includes planes P00, P01, P02 and P03 has a capacity of 32 GB. In an embodiment, 16 memory die are included in a memory package, and the memory package has a capacity of 16×32 GB=512 GB. Other capacities per memory die, and other numbers of memory die per memory package may be used.

In an embodiment, a memory die that includes planes P00, P01, P02 and P03 has a read latency (“tR”) of approximately 15 psec. The per-die bandwidth can be determined from read latency and the logical page size as follows:

$$BW = \frac{( 16 kB \times \frac{1024 B}{kB} )}{15 \times 1 {0}^{- 6} sec} \times 4 planes = 4.4 GB / s$$

In an embodiment, a memory die that includes planes P00, P01, P02 and P03 has an 8 bit I/O, and has an I/O speed of 4.8 G-transfers/s. Because the I/O speed (4.8 G-transfers/s) is faster that the memory die data rate (4.4 GB/sec), the I/O speed is not a factor limiting the data rate of the memory die.

In an embodiment, the number of planes per memory die is increased to increase the memory die bandwidth. For example, FIG. 7B is a diagram depicting a memory structure that includes 32 planes: four planes in the x-direction (e.g., planes P00, P01, P02 and P03) and eight planes in the y-direction (e.g., planes P03, P13, P23, P33, P43, P53, P63 and P73).

In an embodiment, each of planes P00, P01, P02, . . . , P72 and P73 is divided into two sub-planes. For example, plane P00 includes a first sub-plane P00₀ and a second sub-plane P001, a second sub-plane P01 includes a first sub-plane P01₀ and a second sub-plane P01₁, . . . , and a thirty-secondth sub-plane P73 includes a first sub-plane P73₀ and a second sub-plane P731.

In an embodiment, each of planes P00, P01, P02, . . . , P72 and P73 includes a logical page and a physical page size. In the embodiment of FIG. 7B, the physical page size is 8 kB/page, and each logical page includes two physical pages (i.e., 16 kB per logical page).

The structure of FIG. 7B can be derived from the structure of FIG. 7A by keeping the same number of planes in the x-direction (4 planes in x-direction), splitting the planes in half in the y-direction, and repeating four copies (for a total of 8 planes in y-direction), for a total of 4×8=32 planes per memory die. This is 8 times the number of planes of FIG. 7A embodiment. Thus, the total capacity of each die is 0.5×8×32 GB=128 GB and the bandwidth of each die is 8×4.4 GB/s=35.2 GB/s.

In an embodiment, 16 memory die are included in a memory package, and thus the memory package has a capacity of 16×128 GB=2 TB. Each memory package has a bandwidth of 16×35.2 GB/s=563.2 GB/s. To provide a bandwidth of approximately 3 TB/sec, 5 memory packages would be required, which is practical.

To provide this bandwidth, the number of I/O per die must be increased. As described above, an 8 bit I/O has a speed of 4.8 G-transfers/s. If the number of I/O are increased by a factor of 8 to 64 I/O, the I/O speed increases to 8×4.8 G-transfers/s=38.4 G-transfers/s, which is faster that the memory die data rate (35.2 GB/sec).

In additional embodiments, memory die bandwidth can be increased by reducing the physical page size to reduce read latency tR. For example, FIG. 7C is a diagram depicting a memory structure that includes 32 planes: eight planes in the x-direction (e.g., planes P00, P01, . . . , and P07) and four planes in the y-direction (e.g., planes P07, P17, P27 and P37).

In an embodiment, each of planes P00, P01, P02, . . . , P36 and P37 is divided into two sub-planes. For example, plane P00 includes a first sub-plane P00₀ and a second sub-plane P001, a second sub-plane P01 includes a first sub-plane P01₀ and a second sub-plane P01₁, . . . , and a thirty-secondth sub-plane P37 includes a first sub-plane P37₀ and a second sub-plane P37₁.

In an embodiment, each of planes P00, P01, P02, . . . , P36 and P37 includes a logical page and a physical page size. In the embodiment of FIG. 7C, the physical page size is 4 kB/page, and each logical page includes two physical pages (i.e., 8 kB per logical page).

The structure of FIG. 7C can be derived from the structure of FIG. 7B by dividing each 8 kB plane into two 4 kB planes in the x-direction (8 planes in x-direction), and reducing the number of planes by half in the y-direction (4 planes in y-direction), for a total of 32 planes. This is the same number of planes as the FIG. 7B embodiment. The total capacity of each die is 64 GB.

By cutting each word line in half (from 8 kB to 4 kB), the read latency tR decreases. In an embodiment, the read latency tR of the embodiment of FIG. 7C is 4 psec (compared with a read latency tR of 15 μsec for the FIG. 5B embodiment). The per-die bandwidth can be determined from read latency and the logical page size as follows:

$$BW = \frac{( 8 kB \times \frac{1024 B}{kB} )}{4 \times {10}^{- 6} sec} \times 32 planes = 66 GB / s$$

In an embodiment, 16 memory die are included in a memory package, and thus the memory package has a capacity of 16×64 GB=1 TB. Each memory package has a bandwidth of 16×66 GB/s=1.1 TB/s. To provide a bandwidth of approximately 3 TB/sec, 3 memory packages are included.

To provide this bandwidth, the number of I/O per die must be increased. As described above, an 8 bit I/O has a speed of 4.8 G-transfers/s. If the number of I/O are increased by a factor of 16 to 128 I/O, the I/O speed increases to 16×4.8 G-transfers/s=77 G-transfers/s, which is faster than the memory die data rate (66 GB/sec).

The memory die bandwidth can be further increased by further reducing the physical page size to reduce read latency tR. For example, FIG. 7D is a diagram depicting a memory structure that includes 32 planes: eight planes in the x-direction (e.g., planes P00, P01, . . . , and P07) and four planes in the y-direction (e.g., planes P07, P17, P27 and P37).

In an embodiment, each of planes P00, P01, P02, . . . , P36 and P37 is divided into two sub-planes. For example, plane P00 includes a first sub-plane P00₀ and a second sub-plane P001, a second sub-plane P01 includes a first sub-plane P01₁ and a second sub-plane P01₁, . . . , and a thirty-secondth sub-plane P37 includes a first sub-plane P37₀ and a second sub-plane P37₁.

In an embodiment, each of planes P00, P01, P02, . . . , P36 and P37 includes a logical page and a physical page size. In the embodiment of FIG. 7D, the physical page size is 2 kB/page, and each logical page includes two physical pages (i.e., 4 kB per logical page).

The structure of FIG. 7D can be derived from the structure of FIG. 7C by dividing each 4 kB plane into two 2 kB planes in the x-direction (8 planes in x-direction), and keeping the same number of planes by half in the y-direction (4 planes in y-direction), for a total of 32 planes. This is the same number of planes as the FIG. 7C embodiment. The total capacity of each die is 32 GB.

By cutting each word line in half (from 4 kB to 2 kB), the read latency tR decreases. In an embodiment, the read latency tR of the embodiment of FIG. 5D is 1.7 psec (compared with a read latency tR of 15 μsec for the FIG. 7B embodiment and a read latency of 4 μsec for the FIG. 7C embodiment). The per-die bandwidth can be determined from read latency and the logical page size as follows:

$$BW = \frac{( 4 kB \times \frac{1024 B}{kB} )}{1.7 \times {10}^{- 6} sec} \times 32 planes = 77 GB / s$$

In an embodiment, 8 memory die are included in a memory package, and thus the memory package has a capacity of 8×32 GB=256 GB. Each memory package has a bandwidth of 8×77 GB/s=616 GB/s. To provide a bandwidth of approximately 3 TB/sec, five memory packages are included.

To provide this bandwidth, the number of I/O per die must be increased. As described above, an 8 bit I/O has a speed of 4.8 G-transfers/s. If the number of I/O are increased by a factor of 16 to 128 I/O, the I/O speed increases to 16×4.8 G-transfers/s=77 G-transfers/s, which is about the same as the memory die data rate (77 GB/sec).

Without wanting to be bound by any particular theory, it is believed that the techniques described above for (1) increasing the number of memory planes per memory die, (2) increasing the number of input/output (I/O) per memory die to accommodate the increased bandwidth of the memory die, and (3) reducing the physical page size to decrease read latency may provide HBF memory with a bandwidth of about 3 TB/s.

A first technique to improve the power efficiency of the HBF units 26 is to reduce the supply voltage. The power consumed by a NAND array is approximately equal to VCC×ICC, where VCC is the supply voltage and ICC is the supply current. For current NAND memory, a supply voltage of VCC=2.5 V is typically used. One technique for reducing power consumption (and thereby improve the power efficiency) is to reduce supply voltage VCC, such as VCC=1.2 V.

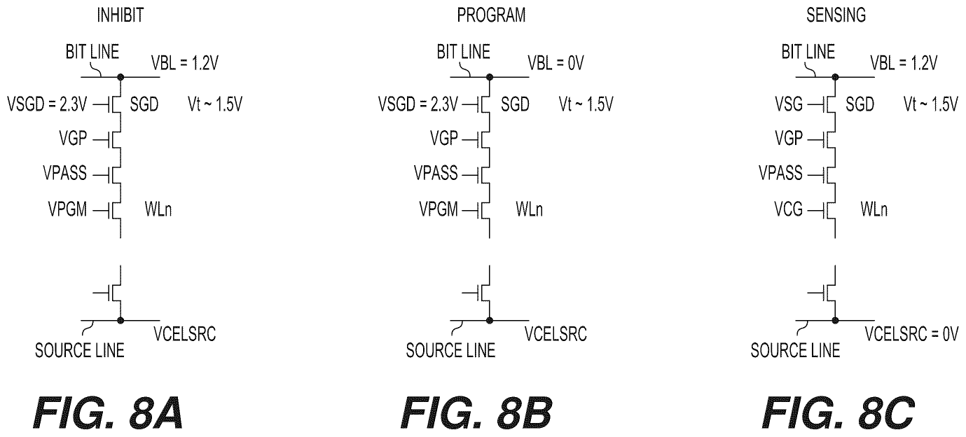

With the reduced supply voltage VCC, the memory device must still perform various functions, such as programming, inhibiting, and sensing. FIGS. 8A-8C depict an example NAND string during these three different memory operations. In particular FIGS. 8A-8C depict an example NAND string during inhibit, program and sensing, respectively.

For inhibit, depicted in FIG. 8A, the 1.2 V VCC is provided to the inhibit bit line. This voltage needs to be high enough to cut off the unselected SGD transistors to provide the channel boosting to provide the inhibit operation. That is, (VSGD−VDD)<Vt.

For programming, depicted in FIG. 8B, a bit line voltage VBL=0 V is delivered to the channel. This requires that the bias VSGD on the SGD cells is greater than the threshold voltage of the SGD cells, VSGD>Vt. In an embodiment, the threshold voltage of the SGD cells is approximately 1.5 V.

Thus, for inhibit we require that (VSGD−VDD)<Vt, and for programming we require that VSGD>Vt. From these two requirements the following can be derived:

$$VSGD > Vt upper tail$$

$$VSGD < VDDSA + Vt lower tail$$

In embodiments, the Vt lower tail is about 1.5 V and the Vt upper tail is about 1.9 V, and VDDSA is about 1.1 V. Thus, from the two conditions above:

1.9 V<VSGD<2.6 V

For sensing, depicted in FIG. 8C, the bit line voltage VBL needs to provide enough drain-to-source voltage for the NAND string. In a conventional NAND device a source line voltage VCELSRC is set to 1 V. In such a scenario, the bit line voltage needs to provide VBLC (˜0.2 V)+VCELSRC+a few transistor threshold voltages+some temperature compensation (TCO) voltage, which leads to approximately 1.5 V, which cannot be derived from VCC if VCC=1.2 V. Therefore, the source line voltage VCELSRC is instead set to 0 V in a scheme that is referred to herein as a “positive sensing” scheme. Because the source line voltage VCELSRC is set at the lower voltage, the bit line voltage needs to provide VBLC (˜0.2 V)+0 V+a few transistor threshold voltages+some temperature compensation (TCO) voltage, which leads to approximately 0.5 V, which can be provided with the lower VCC=1.2 V. Thus, the VCC 1.2 V external power supply can offer the proper voltage for the HBF units 26.

A second technique to improve the power efficiency of the HBF units 26 is to reduce all internal voltages inside the NAND device. In an example embodiment the Vread, VDDSA, and VBL voltages are set as follows:

| | Conventional NAND | HBF |
|---|---|---|
| Vread (V) | 4.7 | 2.4 |
| VDDSA (V) | 2.2 | 1.1 |
| VBL (V) | 0.3 | 0.15 |
| Isense (nA) | 20 | 10 |

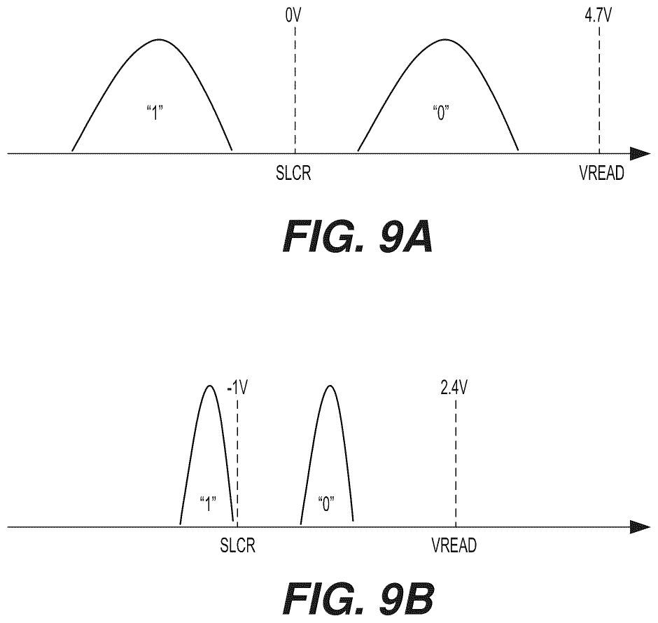

FIG. 9A depicts an example threshold voltage distribution of a NAND memory cell. In particular, the example threshold voltage distribution includes an erased state (e.g., “1”) distribution and a programmed state (e.g., “0”) distribution for a conventional NAND memory cell.

In the illustrated example, both threshold distributions are broad (e.g., such as may be achieved using a one program, zero verify “1P0V” program method) and there is a wide separation between the two threshold distributions. In the depicted example, a read verify level SLCR of 0 V is used and unselected word lines are biased at a voltage of Vread=4.7 V.

FIG. 9B depicts an example threshold voltage distribution of a page of memory cells in an HBF unit 26 (shown in FIGS. 1 and 2). In particular, the example threshold voltage distribution includes an erased state (e.g., “1”) distribution and a programmed state (e.g., “0”). Because programming operations in the HBF unit 26 are performed infrequently, during programming the threshold voltage distributions can be made very narrow, much narrower than the threshold voltage distribution of a conventional NAND memory device depicted in FIG. 9A.

In addition, the gap between the two distributions can be made very close together. By reducing the gap and the threshold voltage distribution width, the unselected word line voltage of Vread can be reduced from a conventional voltage, e.g., 4.7 V. In an exemplary embodiment, Vread is set to 2.4 V to further reduce power consumption.

In addition, in an exemplary embodiment of an HBF unit 26, the read verify level SLCR can be reduced from 0 V (e.g., in the middle of the two distributions in FIG. 9A). In an embodiment, read verify level SLCR is set at the upper tail of the erase distribution. For example, read verify level SLCR=−1 V or some other level. By setting read verify level SLCR at the upper tail of the erase distribution, the amount of overdrive between the erase state distribution and the read verify level SLCR is reduced, which in turn reduces power consumption during sensing.

As described above, the LoRA machine learning technique is read intensive for the HBF units 26. As a result, the HBF units 26 will experience a lot of read disturb. Conventionally, after severe read disturb is experienced in one block, the data is relocated to a new block (called “relocation”), and then the host can continue reading from the new block.

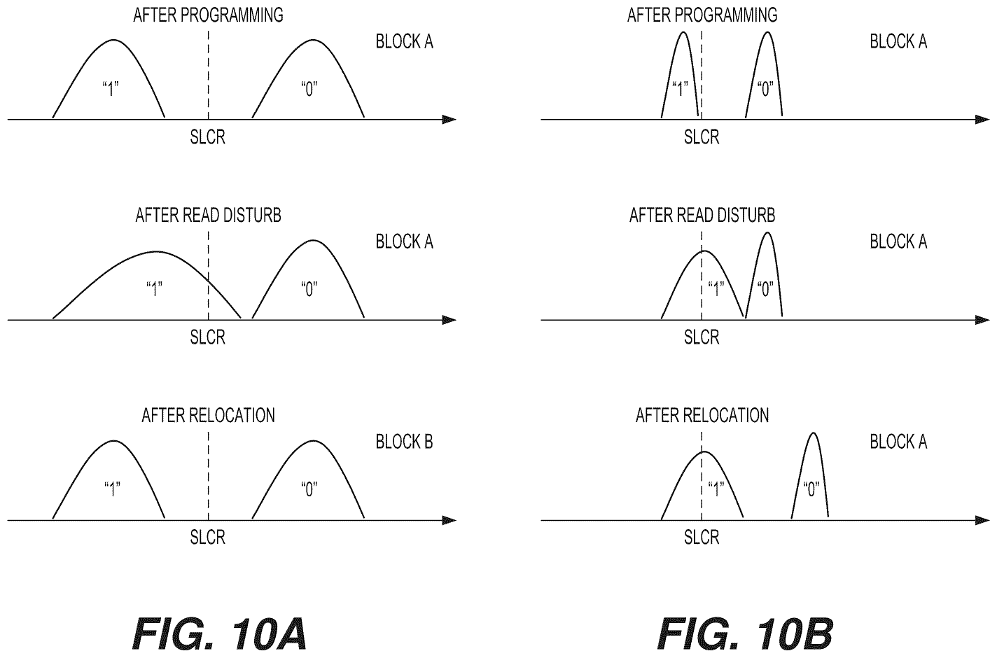

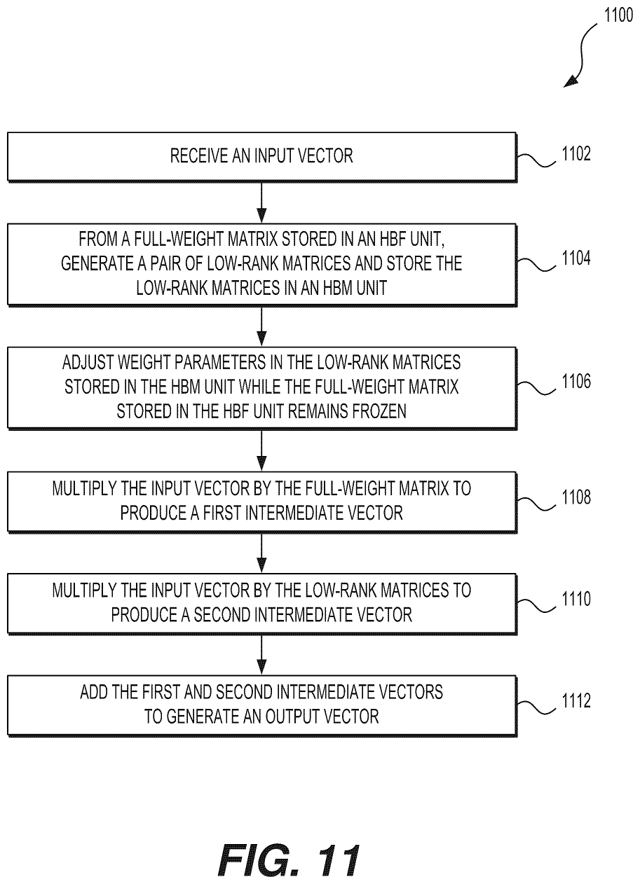

For example, FIG. 10A depicts example threshold voltage distributions of two blocks of NAND memory cells. In particular, the top diagram depicts threshold voltage distributions immediately after programming the block (e.g., block A). After some large number of reads of the same block (e.g., one hundred thousand reads), the erase distribution will widen and the erase upper tail will encroach on the program state lower tail, such as depicted in the middle diagram of FIG. 10A. As a result, the margin between the erased state and the programmed state shrinks.

In a conventional technique, whenever the block reads are detected as almost failing, the data in the block are relocate to a new lock (e.g., block B). In particular, a replacement block B is located, the data in block B is erased, and the data in block A is read and then programmed to block B, resulting in the example threshold voltage distribution depicted in the bottom diagram of FIG. 10A.

Although this results in well-defined threshold voltage distributions in the relocated block, this requires consuming a program-erase cycle to program the data to new block B, which hurts endurance. In addition, the block management function becomes more complicated because a logical-to-physical block table must keep track of the relocated data.

To avoid these technical problems, an alternative “in-place read refresh” technique for addressing read disturb is described that eliminates the need to erase memory cells. Instead, the data in the same block that experiences read disturb is refreshed.

In embodiments, the described in-place read refresh technique may be implemented by any one of or any combination of memory controller 304, state machine 428, all or a portion of system control logic 408, all or a portion of row control circuitry 404, all or a portion of column control circuitry 416, a microcontroller, a microprocessor, and/or other similar functioned circuits.

For example, FIG. 10B depicts example threshold voltage distributions of a single block of NAND memory cells. In particular, the top diagram depicts threshold voltage distributions immediately after programming the block (e.g., block A). This is similar to the distributions in the top diagram of FIG. 10A, but here the threshold voltage distributions are very narrow and closer together, such as described above in FIG. 9B.

After a predetermined number of reads of the same block (e.g., one hundred thousand reads), the erase distribution will widen and the erase upper tail will encroach on the program state lower tail, such as depicted in the middle diagram of FIG. 10B. As a result, the margin between the erased state and the programmed state shrinks.

In an embodiment, just before read failure is detected, instead of finding another block (B) to erase and program, an in-place read refresh is performed. In an embodiment, additional program pulses are applied to the programmed state memory cells, to shift the programmed state threshold distribution higher to increase separation from the erase state distribution.

For example, as depicted in the bottom diagram of FIG. 10B, the threshold voltage distribution of the programmed state memory cells are shifted higher, increasing the separation from the threshold voltage distribution of the erased state memory cells. In embodiments, this process can be repeated—increasing the program state distribution as the erase state distribution widens.

In the embodiment of FIG. 9B, the erase state and program state distributions are very close together and very narrow. As a result, the in-place read-refresh technique has a lot of room to keep pushing the program state distribution higher and higher as necessary for read refresh.

U.S. patent application Ser. No. 18/635,524, filed on Apr. 15, 2024, and entitled “A HIGH BANDWIDTH MEMORY DEVICE WITH ALWAYS ON BIT LINES” discusses other features that may be included in the HBF units 26 and is herein incorporated by reference.

FIG. 11 is a flow chart 1100 depicting the steps of performing a LoRA iteration on an example computing system, e.g., the computing system 20 illustrated in FIG. 1. These steps could be performed by the controller; a processor or processing device or any other circuitry, executing instructions stored in memory; an artificial intelligence training means; and/or other circuitry described herein that is specifically configured/programmed to execute the following steps.

At step 1102, an input vector is received. At step 1104, from the full-weight matrix 200 stored in at least one of the HBF units 26, a pair of low-rank matrices 202a, 202b are generated and stored in at least one of the HBM units 24. At step 1106, the weight parameters in the low-rank matrices 202a, 202b are adjusted while the full-weight matrix 200 stored in the at least one HBF unit 26 remains frozen. At step 1108, the input vector is multiplied by the full-weight matrix 200 to produce a first intermediate vector. At step 1110, the input vector is multiplied by the low-rank matrices 202a, 202b to produce a second intermediate vector. At step 1112, the first and second intermediate vectors are added together to generate an output vector.

For purposes of this document, reference in the specification to “an embodiment,” “one embodiment,” “some embodiments,” or “another embodiment” may be used to describe different embodiments or the same embodiment.

For purposes of this document, a connection may be a direct connection or an indirect connection (e.g., via one or more others parts). In some cases, when an element is referred to as being connected or coupled to another element, the element may be directly connected to the other element or indirectly connected to the other element via intervening elements. When an element is referred to as being directly connected to another element, then there are no intervening elements between the element and the other element. Two devices are “in communication” if they are directly or indirectly connected so that they can communicate electronic signals between them.

For purposes of this document, the term “based on” may be read as “based at least in part on.”

For purposes of this document, without additional context, use of numerical terms such as a “first” object, a “second” object, and a “third” object may not imply an ordering of objects, but may instead be used for identification purposes to identify different objects.

For purposes of this document, the term “set” of objects may refer to a “set” of one or more of the objects.

The foregoing detailed description has been presented for purposes of illustration and description. It is not intended to be exhaustive or to limit to the precise form disclosed. Many modifications and variations are possible in light of the above teaching. The described embodiments were chosen in order to best explain the principles of the proposed technology and its practical application, to thereby enable others skilled in the art to best utilize it in various embodiments and with various modifications as are suited to the particular use contemplated. It is intended that the scope be defined by the claims appended hereto.

What is claimed is:

1. A method of training a large language model using a low rank adaptation (LoRA) technique, comprising the steps of:
preparing a computing system that includes at least one processing unit and at least one high bandwidth memory (HBM) unit in electrical communication with the at least one processing unit and at least one high bandwidth flash (HBF) unit in electrical communication with the at least one processing unit;
storing a full-weight matrix in the at least one HBF unit; and
storing at least one low-rank matrix in the at least one HBM unit.

2. The method as set forth in claim 1, further including the step of generating the at least one low-rank matrix from the full-weight matrix.

3. The method as set forth in claim 2, wherein the step of generating the at least one low rank matrix from the full-weight matrix includes the step of generating a pair of low-rank matrices from the full-weight matrix.

4. The method as set forth in claim 3, further including the step of adjusting the low-rank matrices based on an input.

5. The method as set forth in claim 4, wherein after the step of adjusting the low-rank matrices based on the input, the method further includes the step of adjusting the full-weight matrix based on the adjusted low-rank matrices.

6. The method as set forth in claim 1, wherein the at least one HBF unit includes a plurality of HBF units that do not allow random access, and
wherein the plurality of HBF units have arrays of memory cells that are arranged in a plurality of word lines and memory holes.

7. The method as set forth in claim 1, wherein the at least one HBM unit includes a plurality of HBM units that allow random access.

8. The method as set forth in claim 7, wherein the plurality of HBM units are dynamic random access memory (DRAM).

9. The method as set forth in claim 1, wherein the at least one HBF unit has a bandwidth of at least 3 TB/s.

10. A computing system, comprising:
at least one processing unit, at least one high bandwidth memory (HBM) unit in electrical communication with the at least one processing unit, and at least one high bandwidth flash (HBF) unit in electrical communication with the at least one processing unit;
control circuitry that is configured to train a large language model according to a low-rank adaptation (LoRA) technique, the control circuitry being configured to;
store a full-weight matrix in the at least one HBF unit, and
store at least one low-rank matrix in the at least one HBM unit.

11. The computing system as set forth in claim 10, wherein the control circuitry is configured to generate the at least one low-rank matrix from the full-weight matrix.

12. The computing system as set forth in claim 10, wherein the at least one low-rank matrix includes a pair of low-rank matrices.

13. The computing system as set forth in claim 12, wherein the control circuitry is configured to adjust the low-rank matrices based on an input.

14. The computing system as set forth in claim 13, wherein after adjusting the low-rank matrices based on the input, the control circuitry is configured to adjust the full-weight matrix based on the adjusted low-rank matrices.

15. The computing system as set forth in 10 wherein the at least one HBF unit includes a plurality of HBF units that do not allow random access, and
wherein the plurality of HBF units have arrays of memory cells that are arranged in a plurality of word lines and memory holes.

16. The computing system as set forth in claim 10, wherein the at least one HBM unit includes a plurality of HBM units that allow random access.

17. The computing system as set forth in claim 16, wherein the plurality of HBM units are dynamic random access memory (DRAM).

18. The computing system as set forth in claim 10, wherein the at least one HBF unit has a bandwidth of at least 3 TB/s.

19. An apparatus, comprising:
at least one processing unit, at least one high bandwidth memory (HBM) unit that is volatile and is in electrical communication with the at least one processing unit, and at least one high bandwidth flash (HBF) unit that is non-volatile and is in electrical communication with the at least one processing unit;
an artificial intelligence training means for training a large language model according to a low-rank adaptation (LoRA) technique, the artificial intelligence training means being configured to;
store a full-weight matrix in the at least one HBF unit, and
store at least one low-rank matrix in the at least one HBM unit.

20. The apparatus as set forth in claim 19, wherein the artificial intelligence training means is configured to adjust the at least one low-rank matrix based on an input and then adjust the full-weight matrix based on the adjusted at least one low-rank matrix.
